(19) United States
(12) Patent Application Publication
(10) Pub. No.: US 2026/0118162 A1
(43) Pub. Date: Apr. 30, 2026

(54) AN OPTICAL DETECTION SYSTEM

(71) Applicant: Sintela Limited, Bristol (GB)

(72) Inventor: Stuart RUSSELL, Bristol (GB)

(73) Assignee: Sintela Limited, Bristol, GB (GB)

(21) Appl. No.: 19/165,828

(22) PCT Filed: Jan. 15, 2024
(86) PCT No.: PCT/EP2024/050810

§ 371 Date: Sep. 16, 2025

(30) Foreign Application Priority Data
Mar. 29, 2023 (GB) 2304639.4

(51) Int. Cl. G01H 9/00; G01D 5/353

(52) U.S. Cl. CPC G01H 9/004; G01D 5/35361; G01D 5/35364

(57) ABSTRACT

An optical detection system defined by a distributed acoustic sensing system (“DAS”) and related signal processing. The DAS has a coherent light source that generates a light signal; a launch stage configured to receive the light signal, generate a test signal, and launch the test signal along an optical path. The test signal has a periodic step increase in frequency. A local oscillator stage generates a local oscillator signal having a periodic step increase in frequency which is offset relative to the test signal in each of a time domain and a frequency domain, with the offset being by a user defined time delay and offset by a system defined frequency shift relative to the test signal. A detector stage receives the local oscillator signal and a scattered signal from the optical path. An output signal is defined by interference terms between the scattered signal and the local oscillator signal.

### FIELD OF THE INVENTION

The present invention relates to an optical detection system, in particular a distributed acoustic sensing system and related signal processing methods.

### BACKGROUND

Distributed Acoustic Sensing (DAS) is an established technology with several commercial systems available. In these systems, a pulse or pulses of laser light are launched into a length of optical fibre and the light that is scattered within the fibre is analysed in order to derive the nature of the acoustic environment, i.e. any physical vibrations, of the fibre transducer. In particular, these systems typically make a measurement of the acoustic strain environment of an optical fibre transducer using an optical time domain reflectometer (OTDR) approach. This gives a differential strain measurement as a function of position along the optical fibre.

As an optical fibre is manufactured it is cooled or quenched from a high temperature as it is drawn. This process leads to the presence of small variations in the density of the optical fibre. These tiny variations in density equate to variations in the effective refractive index of the fibre. These discontinuities lead to scattering of laser light passing through the optical fibre, particularly by Rayleigh scattering. The amplitude of the scattering follows a Rayleigh distribution, but the phase angle of the scattering is uniformly distributed around a unit circle, i.e. −π≤φ≤π where φ is the phase angle.

For a single pulse system the length of the fibre limits the pulse repetition frequency (PRF) possible, as only one laser light pulse should interrogate the fibre at a given time. Therefore, a pulse is only sent down the optical fibre when the previous pulse has had time to travel the full length of the fibre and the scattered light return to the detector. As a result, the acoustic environment at any location of the fibre can only be sampled at the PRF and this sets an inherent limit on the maximum acoustic frequency that can be sampled with a single pulse system, related to the Nyquist limit.

Many systems only measure the amplitude of the light scattered by the fibre, which yields a result that correlates to the acoustic field only for small amplitude strains and only when correct fibre scatter bias conditions, i.e., the resulting scatter amplitude and phase as a result of the coherent sum of the scattering of light from all of the scattering sites which are illuminated at a given time, are met. For large acoustic strains or incorrect fibre scatter bias conditions these systems significantly distort the measurement of the acoustic field leading to the generation of higher frequency components which do not truly represent the amplitude or time evolution of the vibrations which are affecting the optical fibre. Systems of this nature however do give a measure of the acoustic energy and have found application for long range installations such as pipeline monitoring and borders, where detection of activity is the primary goal and a truly accurate measurement of the acoustic field is not required. Systems of this nature can be termed ‘qualitative’ systems. Operational ranges of less than 50 km, and spatial resolutions of the order of more than 20 m at these ranges are typical for such systems.

Other systems simultaneously measure the amplitude and phase of the scattered light, typically by comparing the phase of two sequential pulses or by comparing the phase of one pulse with a delayed copy of itself. In each case, said pulses are allowed to optically interfere and the resulting interference is measured. These systems yield a response which is generally linearly related to the acoustic field and the response provides a much higher dynamic range. Such systems are therefore able to represent much larger strains in the optical fibre and with much greater correlation to the acoustic field than ‘qualitative’ methods as described above. However, typically the operational range of systems of this nature is limited and therefore are targeted at shorter range applications, for example down hole seismic measurements. Systems of this nature can be termed ‘quantitative’ systems. Operational ranges of 10 km or less, and spatial resolutions of the order of 10 m are typical for such systems.

Another way of measuring the amplitude and phase of the scattered light in a ‘quantitative’ system is to use a local oscillator reference signal and measure the phase of the scattered light in relation to this reference. This method is termed coherent detection. Coherent detection has found application in communications and sensors in various forms over the past 30 years. It offers not only a coherent measurement of both phase and amplitude but also a detection noise floor much lower than direct detection methods and hence the potential for improved range and spatial resolution performance when compared to other commercial systems. However, the traditional signal processing approach to employing coherent detection to build a DAS system leads to issues which limit these inherent advantages.

The present invention has been devised in light of the above considerations.

### SUMMARY OF THE INVENTION

At its most general, the present invention provides a development of the distributed acoustic sensing (DAS) systems and associated processing methods set out in GB 2588177 A, which is incorporated herein by reference. In particular, the invention may enable an improved signal signal-to-noise ratio (SNR) of the DAS system, thus enabling acoustic modulations along an optical path to be determined with higher fidelity or greater spatial resolution.

In particular, according to a first aspect of the present invention there is provided a distributed acoustic sensing (DAS) system comprising a coherent light source configured to generate a light signal; a launch stage configured to receive the light signal from the light source, generate a test signal, and launch the test signal along an optical path, wherein the test signal comprises a periodic step increase in frequency (such that the test signal may be said to comprise or form a frequency staircase); a local oscillator stage configured to generate a local oscillator signal, wherein the local oscillator signal comprises a periodic step increase in frequency which is offset relative to the test signal in each of a time domain and a frequency domain (such that the local oscillator signal also comprises or forms a frequency staircase, offset by a user defined time delay and offset by a system defined frequency shift relative to the test signal); and a detector stage configured to: receive the local oscillator signal from the local oscillator stage and a scattered signal from the optical path; and interfere the local oscillator signal with the scattered signal to produce an output signal having interference terms between the scattered signal and the local oscillator signal. By providing a DAS system which utilises a test signal and a local oscillator signal having respective periodic step increases in frequency in this way, the present invention allows at least a section of the optical path to be interrogated with an effectively increased pulse repetition frequency (PRF), increasing the inherent sample rate and thereby yielding a higher signal to noise ratio (SNR) when compared with known systems. In particular, the SNR increases with the number of frequency steps in the test signal. The effect of probing a portion of the optical path with an increased SNR may be known as acoustic zoom, as it provides a system which can zoom in on, or enhance, the acoustic environment (e.g., vibrations) of at least a portion of the optical path. In comparison, conventional DAS systems reveal the acoustic environment along the whole of the optical path, but at a reduced SNR. As will be explained in more detail below, the time offset between the local oscillator signal and the test signal may set the spatial location on the launch path at which interference and mixdown between the scattered signal and the local oscillator signal occurs—this location may set the portion of the launch path which is interrogated with the increased PRF and SNR. A DAS system according to the present invention may achieve such effects without reducing the available spatial resolution or creating spatial crosstalk in the final output, as explained herein. For example, such a DAS system may be used for monitoring physical vibrations of an optical fibre, or at least a portion of an optical fibre, with an increased sensitivity compared with known systems. A signal which has a periodic step increase in frequency may be referred to herein as having a ‘frequency staircase’ or being a ‘stepped’ signal.

Optionally, the launch stage is configured to increase the frequency of the test signal by steps until a round-trip transit time for the test path (e.g., a fibre under test) is reached. The frequency staircase is then reset, and starts over to interrogate the test path again. In some examples, if the launch stage (e.g., a modulator forming part of the launch stage) has insufficient bandwidth to allow such a frequency staircase to fill the round-trip transit time for the test path, the frequency may be increase step by step until a maximum frequency is reached, and then the amplitude of the test signal is decreased to zero for the remainder of the pulse interrogation period until the round-trip transit time is reached, when the frequency staircase is reset. In particular, the periodic step increase in frequency of the local oscillator signal has the same pitch of the frequency staircase pattern as the periodic step increase in the test signal, and is simply offset in both the time and frequency domains.

Optionally, the periodic step increase in the frequency of the test signal is configured to separate the interference terms in the output signal to minimise spectral overlap or crosstalk. For example, such configuration may comprise adjusting the amount of the increase in frequency between successive frequency steps. Such an arrangement may help in processing of the interfered local oscillator and test signals, for example so that such processing may be carried out more efficiently and accurately.

Optionally, the periodic step increase in frequency of the test signal may be configured to achieve a predetermined spatial resolution. In particular, the time between successive increases in frequency (that is, the temporal pitch between step increases) may be configured to achieve a predetermined spatial resolution, as this alters an effective measurement gauge length which is provided by the test signal. In some examples, the spatial resolution may also be configured by adjusting the amplitude modulation envelope of each step in the frequency staircase of the transmitted signal.

Optionally, the launch stage may be configured to pulse the test signal such that successive pulses of the test signal comprise different frequencies. In particular, the launch stage may be configured to pulse the test signal over the duration of the frequency staircase, accordingly. For example, the amplitude of the test signal may be modulated (e.g., by amplitude windowing) to define separate pulses for each successive frequency step of the frequency staircase. In some examples, the envelope shape of each pulse may be used to reduce spectral crosstalk and make frequency multiplexing more spectrally efficient.

Optionally, the local oscillator stage may be configured to also generate a continuous wave, CW, local oscillator signal. As explained above, a DAS system according to an embodiment of the present invention may provide an improved PRF and SNR for at least a portion of the launch path. However, by providing an additional CW local oscillator signal in this way, the DAS system may also provide conventional DAS functionality, to assess and detect vibrations along the whole length of the launch path (e.g., a fibre under test). In particular, the additional CW local oscillator field interferes with the scatter from each step of the frequency staircase of the test signal, and analysis of the resulting interference provides a DAS system analysing the whole length of the optical path.

In some embodiments, the local oscillator stage may be configured to offset the CW local oscillator signal relative to the local oscillator signal (that is, the frequency staircase local oscillator signal) in a frequency domain in order to separate interference terms in the output signal. In particular, this may separate interference terms relating to interference between the CW and frequency staircase local oscillator signals from other interference terms in the output signal. It will be appreciated that such separation may minimise or eliminate overlap or crosstalk between these terms. Such an arrangement may help in processing of the interfered local oscillator and test signals, for example so that such processing may be carried out more efficiently and accurately.

In certain embodiments, the launch stage may be configured to generate a test signal further comprising a conventional DAS interrogation pulse having a fixed frequency, which is offset relative to the CW local oscillator signal in the frequency domain. That is, the test signal may also comprise a CW field. Such an arrangement may also provide conventional DAS functionality to assess and detect vibrations along the whole length of the launch path (e.g., a fibre under test). In this way, the SNR of the conventional DAS analysis may be improved, as the analysis may be based on the interference between the frequency staircase test signal and the CW local oscillator signal and, additionally, the interference between the conventional interrogation pulse and the CW local oscillator signal.

According to a second aspect of the present invention, there is provided a signal processing method for a distributed acoustic sensing, DAS, system comprising an acoustic zoom channel, the method comprising: transmitting a pulsed test signal along an optical path, wherein the test signal comprises a periodic step increase in frequency (that is, the test signal comprises a plurality of frequency steps); receiving, at a detector stage, a scattered signal that was scattered at a location along the optical path, wherein the scattered signal comprises a periodic step increase in frequency corresponding with the pulsed test signal (i.e., such that the scattered signal also comprises a plurality of frequency steps); receiving, at the detector stage, a local oscillator signal which is offset relative to the test signal in each of a time domain and a frequency domain, wherein the local oscillator signal comprises a periodic step increase in frequency (in some examples, the local oscillator signal may be a pulsed signal, comprising the plurality of frequency steps across the duration of the pulse); generating, based on an interference between the scattered signal and the local oscillator signal, a set of first complex acoustic zoom carrier signals, wherein each first complex acoustic zoom carrier signal results from interference between a frequency step of the scattered signal and a frequency step of the local oscillator signal and is modulated by a phase difference (in particular, this phase difference is a cumulative phase difference acquired up to the scattering location) between the local oscillator signal and the scattered signal at a spatial location along the optical path determined by the time offset between the pulsed test signal and the local oscillator signal as well as the associated frequency step of the scattered signal (such that each frequency step of the scattered signal corresponds, in the acoustic zoom carrier, with a spatial location along the optical path); generating a set of second complex acoustic zoom carrier signals that are modulated by a spatial differential of the phase difference, the spatial differential being taken along a length of the optical path, based on interference between first complex acoustic zoom carrier signals (e.g., spatially adjacent first complex acoustic zoom carrier signals for a gauge length equal to the spatial/temporal length of the staircase pitch, or non-adjacent carriers for a gauge length which is a multiple of the spatial/temporal length of the staircase pitch); and determining, based on the set of second complex acoustic zoom carrier signals, a value representative of the spatial differential of the phase difference for the location along the optical path for acoustic zoom sensing. By performing distributed acoustic sensing in this way, the present invention allows at least a section of the optical path to be interrogated with an effectively increased pulse repetition frequency (PRF), increasing the inherent sample rate and thereby yielding a higher signal to noise ratio (SNR) when compared with known systems. This effect may be known as acoustic zoom, as it provides a system which can zoom in on, or enhance, the acoustic environment (e.g., vibrations) of at least a portion of the optical path. In comparison, conventional DAS systems reveal the acoustic environment along the whole of the optical path, but at a reduced SNR. As will be explained in more detail below, the time offset between the local oscillator signal and the test signal may set the spatial location on the launch path at which interference and mixdown between the scattered signal and the local oscillator signal occurs—this location may set the portion of the launch path which is interrogated with the increased PRF and SNR. A DAS system operated according to the method of the present invention may achieve such effects without reducing the available spatial resolution or creating spatial crosstalk in the final output, as explained herein. For example, such a DAS system may be used for monitoring physical vibrations of an optical fibre, or at least a portion of an optical fibre, with an increased sensitivity compared with known systems. By taking the spatial differential based on interference between spatially adjacent (or non-adjacent) first complex acoustic zoom carriers, the gauge length of the differential is related to the pitch of the frequency staircase, as described below.

Optionally, the DAS system may further comprise at least one conventional DAS channel, and the method may further comprise: receiving, at a detector stage, a continuous wave, CW, local oscillator signal; generating, based on an interference between the scattered signal and the CW local oscillator signal, a set of first complex DAS carrier signals, wherein each first complex DAS carrier signal results from interference between a frequency step of the scattered signal and the CW local oscillator signal, and is modulated by a phase difference between the CW local oscillator signal and the scattered signal at a spatial location along the optical path determined by a sampling time as well as the associated frequency step of the scattered signal; generating a set of second complex DAS carrier signals that are modulated by a spatial differential of the phase difference, the spatial differential being taken along a length of the optical path; and determining, based on the set of second complex DAS carrier signals, a value representative of the spatial differential of the phase difference for the location along the optical path for distributed acoustic sensing. By providing an additional CW local oscillator signal in this way, a set of DAS carrier signals are provided by interference with each step of the scattered signal, and so the method may also provide conventional DAS functionality, to assess and detect vibrations along the whole length of the launch path (e.g., a fibre under test). In particular, the present invention provides the advantage that several conventional DAS carriers are generated and can be combined according to methods described herein to obtain a conventional DAS signal with improved SNR in addition to acoustic zoom data obtained simultaneously.

The inventors have found that the signal processing methods described in previous applications GB 2588177 A and GB 2609641 A may be modified in order to provide acoustic zoom and/or conventional DAS sensing in a manner which is capable of handling the additional carriers which result from the use of a test signal which comprises frequency steps, and which allows the acoustic field modulating the optical path to be reconstructed without distortion. Description of the modifications required is given herein.

As described herein, each of the acoustic zoom carriers is modulated by a cumulative phase modulation experienced by the scattered light from a location defined by the time offset between the test signal and the local oscillator signal, and the specific frequency steps which interfere to generate the specific carrier. As a result, the modulation on each carrier is coherent over a period equal to the pitch of the frequency step, and there is a different phase bias on successive step periods sampling the acoustic field a short time later. Therefore, in order to recover the spatial differential of phase in the acoustic zoom channel, the differential is taken based on spatially adjacent (or non-adjacent) carriers, and is not based on a time differential (as is the case for conventional DAS). In addition, the inventors have realised that in order to constructively sum carrier signals, the phase bias between individual time sections of data (equal in pitch to the step period) needs to be accounted for in order to align the vectors defined by the complex carrier signals, according to methods described herein.

Optionally, generating a set of second complex DAS carrier signals may further comprise aligning each of the first complex DAS carrier signals in time. For example, this may comprise applying a time delay to each first complex DAS carrier signal according to a corresponding step in the scattered signal (e.g., the temporal delay being a multiple of the time pitch of the frequency staircase).

Optionally, determining a value representative of the spatial differential of the phase difference for distributed acoustic zoom sensing may comprise processing the set of second complex DAS carrier signals to generate a set of third complex DAS carrier signals, the set of third complex DAS carrier signals being modulated by a time differential of the spatial differential of the phase difference, the time differential being over a time period between successive pulses of the test signal; and summing the set of third complex DAS carrier signals.

In another example, determining a value representative of the spatial differential of the phase difference for distributed acoustic zoom sensing may comprise representing the second set of complex DAS carrier signals as a set of phasors; determining a time averaged individual reference phasor for each of the set of phasors and rotating each phasor in the set of phasors by an angle corresponding to a difference between a common reference phasor and the individual reference phasor, wherein the common reference phasor is determined based on a sum of the individual reference phasors representing the set of second complex DAS carrier signals; and summing the rotated phasors to generate a phasor representing a third complex DAS carrier signal.

Alternatively, determining a value representative of the spatial differential of the phase difference for distributed acoustic sensing comprises: storing an initial set of second complex DAS carrier signals generated for each spatial location as a set of reference complex DAS carrier signals for each spatial location; and generating a set of third complex DAS carrier signals associated with each spatial location (each spatial location may be referred to as a spatial channel in the processing method), each third complex DAS carrier signal being modulated by a phase difference between the associated second complex DAS carrier signal and the associated reference complex DAS carrier signal; summing the set of third complex DAS carrier signals associated with each spatial location, to generate a fourth complex DAS carrier signal; determining, based on the fourth complex DAS carrier signal, a value representative of an instantaneous frequency of an acoustic modulation at locations on the optical path corresponding to the respective spatial locations; determining if the value representative of the instantaneous frequency meets a predetermined condition and, if the predetermined condition is met: for each of the respective spatial locations, saving the second complex DAS carrier signal associated with that spatial location as the reference complex DAS carrier signal for that spatial location.

Optionally, determining a value representative of the spatial differential of the phase difference for acoustic zoom sensing may comprise processing the set of second complex acoustic zoom carrier signals to generate a set of third complex acoustic zoom carrier signals, the set of third complex acoustic zoom carrier signals being modulated by a time differential of the spatial differential of the phase difference, the time differential being over a time period between successive pulses of the test signal; and summing the set of third complex acoustic zoom carrier signals.

In another example, determining a value representative of the spatial differential of the phase difference for acoustic zoom sensing may comprise: representing the second set of complex acoustic zoom carrier signals as a set of phasors; determining a time averaged individual reference phasor for each of the set of phasors and rotating each phasor in the set of phasors by an angle corresponding to a difference between a common reference phasor and the individual reference phasor, wherein the common reference phasor is determined based on a sum of the individual reference phasors representing the set of second complex acoustic zoom carrier signals; and summing the rotated phasors to generate a phasor representing a third complex acoustic zoom carrier signal.

Alternatively, determining a value representative of the spatial differential of the phase difference for acoustic zoom sensing may comprise: storing an initial set of second complex acoustic zoom carrier signals generated for each spatial location as a set of reference complex acoustic zoom carrier signals for each spatial location; and generating a set of third complex acoustic zoom carrier signals associated with each spatial location, each third complex acoustic zoom carrier signal being modulated by a phase difference between the associated second complex acoustic zoom carrier signal and the associated reference complex acoustic zoom carrier signal; summing the set of third complex acoustic zoom carrier signals associated with each spatial location, to generate a fourth complex acoustic zoom carrier signal; determining, based on the fourth complex acoustic zoom carrier signal, a value representative of an instantaneous frequency of an acoustic modulation at locations on the optical path corresponding to the respective spatial locations; determining if the value representative of the instantaneous frequency meets a predetermined condition and, if the predetermined condition is met: for each of the respective spatial locations, saving the second complex acoustic zoom carrier signal associated with that spatial location as the reference complex acoustic zoom carrier signal for that spatial location.

The invention includes the combination of the aspects and preferred features described except where such a combination is clearly impermissible or expressly avoided.

### SUMMARY OF THE FIGURES

Embodiments and experiments illustrating the principles of the invention will now be discussed with reference to the accompanying figures in which:

FIG. 1 shows a schematic drawing of a distributed acoustic sensing system according to an embodiment of the present invention;

FIGS. 2a and 2b show respective series of graphs representing a transmitted laser pulse in embodiments of the present invention;

FIG. 3 shows a series of graphs representing a local oscillator field in an embodiment of the present invention;

FIG. 4 is a graph representing the field components due to interference of a scattered signal and a local oscillator field in an embodiment of the present invention;

FIG. 5 shows a series of graphs representing a local oscillator filed in another embodiment of the present invention;

FIG. 6 is a graph representing the field components due to interference of a scattered signal and a local oscillator field in an embodiment of the present invention;

FIG. 7 shows a series of graphs representing a transmitted laser pulse according to a further embodiment of the present invention;

FIG. 8 is a graph representing the field components due to interference of a scattered signal and a local oscillator field in an embodiment of the present invention;

FIG. 9 is a schematic diagram showing an example signal processing method for an acoustic zoom channel;

FIG. 10 is a schematic diagram showing an example signal processing method for a conventional DAS channel;

FIGS. 11(a) and 11(b) show an alternative signal processing method for a conventional DAS channel;

FIG. 12 shows another signal processing method for a conventional DAS channel; and

FIG. 13 is a flow chart showing a signal processing method according to an embodiment of the present invention.

### DETAILED DESCRIPTION OF THE INVENTION

Aspects and embodiments of the present invention will now be discussed with reference to the accompanying figures. Further aspects and embodiments will be apparent to those skilled in the art. All documents mentioned in this text are incorporated herein by reference.

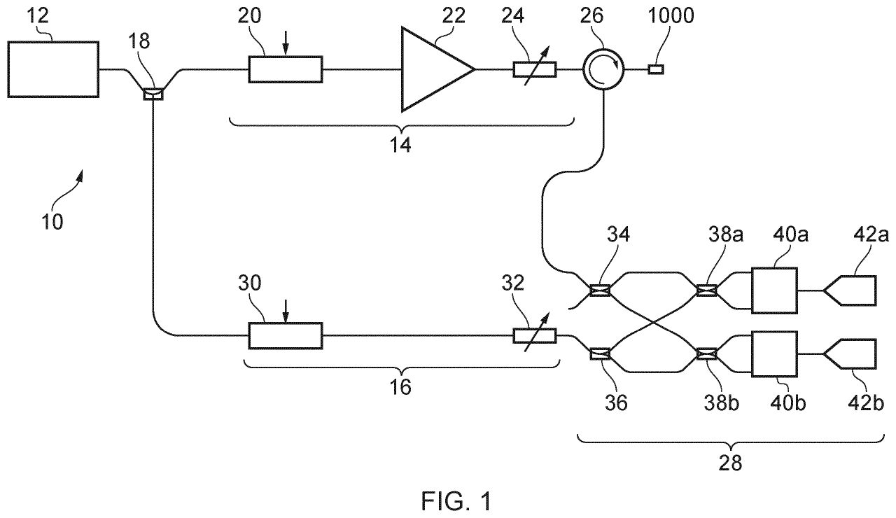

FIG. 1 shows a schematic diagram of a distributed acoustic sensing (DAS) system 10 according to an embodiment of the present invention. The acoustic sensing system 10 is configured to enable at least a section of an optical path (in particular, the optical path is an optical fibre under test 1000) to be interrogated with an effectively increased pulse repetition frequency (PRF), increasing the inherent sample rate and thereby yielding a higher signal to noise ratio (SNR) when compared with known systems. This effect may be known as acoustic zoom, as it provides a system which can zoom in on, or enhance, the fidelity of the measurement of the acoustic environment (e.g., vibrations) of at least a portion of the optical path. The DAS system 1000 is in the form of a local oscillator based optical time domain reflectometer (OTDR) system. The DAS system 10 is arranged to interrogate the optical path, or optical fibre 1000, which may be of any desirable length for a given purpose.

The system 10 comprises a coherent light source 12 which produces a coherent light signal. The light source 12 may be a laser, which may be used in continuous wave (CW) operation. The light source is coupled to a launch stage 14 and a local oscillator stage 16 by an optical coupler 18 or beam splitter. In this manner, a first portion of light emitted by the light source 12 is transmitted to the launch stage 14, and a second portion of the light emitted by the light source is transmitted to the local oscillator stage 16. The light may be split between the two stages by the optical coupler 18 such that 90% of the incoming light is directed into the launch path, and 10% of the incoming light is directed into the local oscillator path. Of course, the ratio of incoming light directed into each stage may be chosen depending on the requirements of the system design. Optionally, an optical isolator (not shown) may be coupled between the light source 12 and the optical coupler 18, to ensure that light is not passed back to the light source 12.

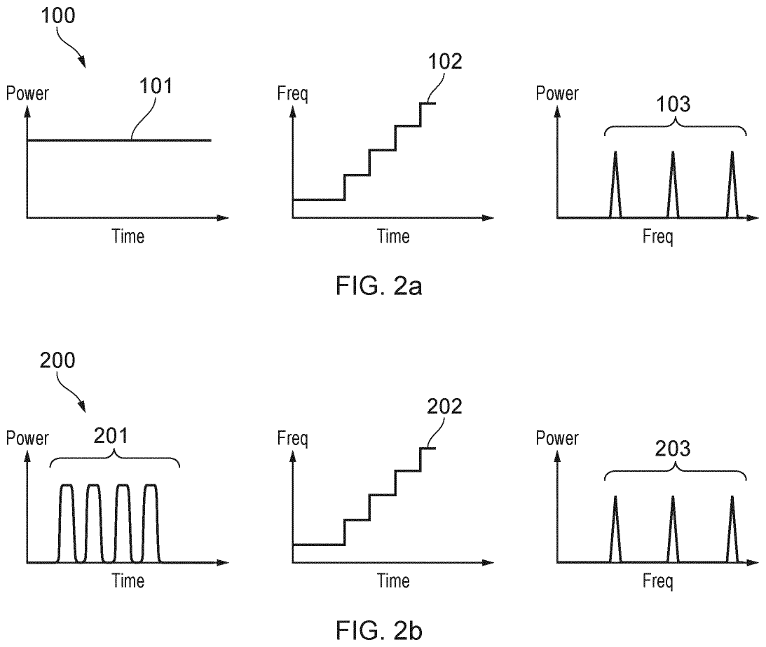

The launch stage 14 includes a pulse generator 20, into which the light signal received at the launch stage 14 from the light source 12 is directed. The pulse generator 20 is a device which is configured to generate a pulsed test signal from the received light signal. In particular, the pulse generator 20 is configured to generate a test signal which comprises a periodic step increase in frequency, as will be shown and discussed in more detail below. The pulse generator 20 may be configured to generate a series of pulses, wherein successive or consecutive pulses comprise a step increase in frequency, or the stepped signal may essentially comprise a single pulse with a longer duration, wherein the step increase in frequency occurs periodically over the length of the pulse. Examples of such pulses are described below with respect to FIG. 2. In certain embodiments, the pulse generator 20 may generate, in addition to a signal comprising a periodic step increase in frequency, a further interrogation pulse having a fixed frequency. By providing a further interrogation pulse having a fixed frequency, the system may provide a DAS system which interrogates and analyses the entirety of the optical path 1000 (e.g., in the manner of a known DAS system) in addition to the acoustic zoom operating along a section of the optical path 1000, as will be described in more detail below.

The pulse generator may be configured to generate a pulsed test signal which is between 5 ns and 100 ns in duration, but not limited to this range. The pulse generator 20 may be an IQ modulator which is implemented, for example, by cascaded arrangement of electro-optic modulators (EOM) or similar. Of course, any preferred method of generating a pulse of light and shifting its optical frequency may be used. The pulsed test signal may also be referred to as a launch pulse.

The launch stage 14 further includes an optical amplifier 22 that is configured to amplify the pulsed test signal. The amplifier 22 may be a master oscillator power amplifier (MOPA). The amplified test pulse may then be passed through an attenuator 24 for controlling a power of the test signal. The launch stage 14 is connected to the optical fibre 1000 via an optical circulator 26, which has three ports. The pulsed test signal enters the circulator 26 through a first port, where it is passed to a second port in order to enter the optical fibre 1000. As the test signal passes through the fibre 1000, a fraction of the light is backscattered from the fibre 1000 by a variety of scattering mechanisms, including Rayleigh scattering, Brillouin scattering and Raman scattering. A portion of the backscattered light is captured and guided back along the optical fibre 1000 towards the circulator 26. The scattered light, which may be referred to herein as a scattered signal, enters the circulator 26 at the second port, and leaves the circulator 26 to enter a detection stage 28 via a third port.

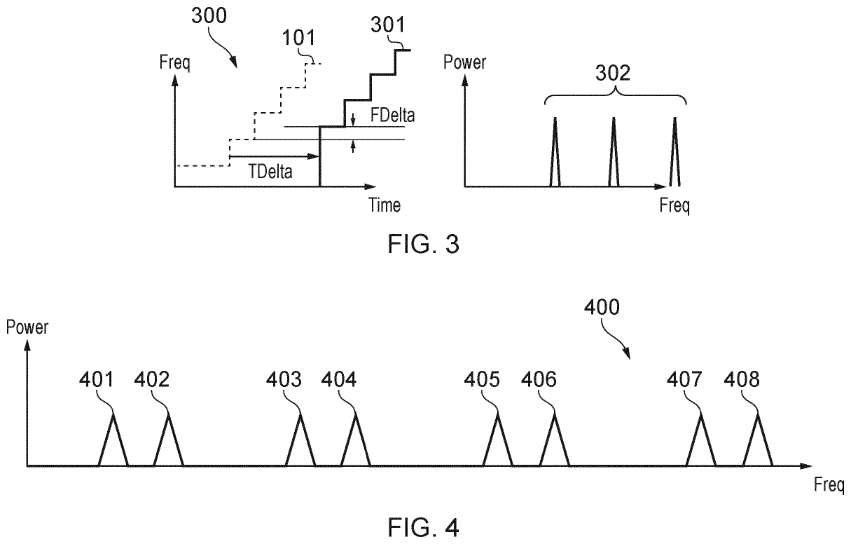

The local oscillator stage 16 includes a modulator 30 which is configured to receive the light signal from the light source 12 and generate a local oscillator signal which also comprises a periodic step increase in frequency. However, the local oscillator signal is offset relative to the test signal in each of a time domain and a frequency domain. An example local oscillator signal which may be generated is described below with respect to FIG. 3. In the example shown in FIG. 1, the modulator 30 is an IQ modulator. The frequency shift applied to the local oscillator component may be controlled by a drive signal that is applied to the modulator 30. The modulator 30 may be implemented by an arrangement of electro-optic modulators (EOM). Typically, the frequency shift applied to the local oscillator compared with the test signal may be between 100 MHz and 500 MHz, for example the frequency shift may be 300 MHz. The local oscillator stage 16 may further include an attenuator 32 for controlling a power of the local oscillator signal. Of course, other arrangements in the local oscillator stage 16 than the one shown in FIG. 1 may be used for generating the two components of the local oscillator signal.

In certain embodiments, the modulator 30 may generate, in addition to a local oscillator signal comprising a periodic step increase in frequency, a continuous wave (CW) local oscillator signal having a fixed frequency. By providing a further CW local oscillator signal having a fixed frequency, the system may provide a DAS system which interrogates and analyses the entirety of the optical path 1000 (e.g., in the manner of a conventional DAS system) in addition to the acoustic zoom operating along a section of the optical path 1000, as will be described in more detail below.

The detector stage 28 has two inputs. The first input of the detector stage 28 is connected to the third output of the circulator 26, to receive the scattered signal from the optical fibre 1000. The second input of the detector stage is connected to the local oscillator stage 16, to receive the local oscillator signal. In a first part of the detector stage 28, the scattered signal is divided into two paths, for example using a polarising beam splitter (PBS) 34. The PBS 34 splits the scattered light into a horizontally polarised state and a vertically polarised state. The PBS 34 is used as the polarisation of the pulsed test signal and also of the scattered signal will evolve as a function of distance as they pass through the optical fibre 1000. The PBS 34 therefore enables polarisation diverse detection, to ensure that a signal can always be detected, regardless of a polarisation state of the scattered signal. The local oscillator (LO) signal, which is highly polarised, is split equally between two paths using a polarisation maintaining optical coupler 36. In other embodiments, the LO signal may be split into two polarisation states in preference to the scattered signal as described.

The detector stage 28 includes first and second optical couplers 38a, 38b, configured to mix the LO signal with a respective one of the horizontal and vertical states of the scattered signal. The detector stage further includes a first square law detector 40a and a second square law detector 40b, on which the light output from each optical coupler 28a, 38b is respectively interfered. The first and second square law detectors each provide a respective output signal, which is respectively taken and measured at an analog-to-digital converter 42a, 42b. Thus, a first output signal is produced for the vertical polarisation stage, and a second output signal is produced for the horizontal polarisation stage.

Due to the presence of different frequency components in the LO signal (due to a staircase in the LO frequency domain, as described below), and the multiple scattering components in the scattered signal, the output signal from each detector 42a, 42b will include a series of components at different frequencies, corresponding to frequency differences between components of the LO signal and the scattered signal. More detail of these components is outlined below.

The DAS signal can be processed in order to extract differential strain information about the optical fibre 1000, and thereby derive the acoustic environment (e.g., vibrations) of the optical fibre 1000. For example, the applicant's earlier applications published as GB 2588177 A and GB 2609641 A (the entirety of which are incorporated herein by reference) provide processing techniques that can be applied to a DAS signal. However, by providing a test signal and a local oscillator signal configured as described herein, and with modifications to the known techniques in accordance with the inventors' realisations and as described in more detail below, the present invention allows this differential strain information to be determined with a much greater SNR at a particular region of interest along the optical path, providing what is referred to herein as an acoustic zoom effect.

The system 10 described above makes use of a heterodyne sensing approach, wherein the frequency of the test signal is frequency-shifted relative to the light source 12 (and thus relative to the first component of the LO signal). Preferably, the difference in frequency difference between the test signal and the first component of the LO signal should be larger than the bandwidth required to represent Rayleigh scattering, without allowing crosstalk between the carrier and the DC terms which are also generated (see below), allowing the phase and amplitude information of the scattering to be recovered using a real carrier. Another method employs a complex carrier detection stage, replicating the polarisation diverse detection stage for two copies of the local oscillator shifted by 90 degrees relative to each other. This allows detection via a complex carrier, allowing either the positive sidelobe or the negative sidelobe of the resulting interference signal to be recovered independently. This allows homodyne operation whereby the first component of the local oscillator signal and test signal operate at the same optical frequency.

FIGS. 2a and 2b show respective series of graphs representing the transmitted laser pulse, or test signal, in embodiments of the present invention.

In a first example, shown by FIG. 2a, a test signal 100 has a constant power 101 (a constant amplitude) over the length of the pulse, and comprises a periodic step increase in frequency 102 for the duration of the pulse. That is, the test signal 100 has a fixed temporal pitch and fixed height staircase in the frequency domain 102, wherein the frequency staircase increases until the round-trip transit time for the fibre 1000 being interrogated is reached where the staircase is reset and starts over. If the modulator 20 has insufficient bandwidth to allow the staircase in the frequency domain 102 to fill the entire round-trip transit time for the fibre 1000, the amplitude of the test signal 100 is modulated to zero for the remainder of the pulse interrogation period before the pulse is reset and repeated for the next interrogation of the fibre 1000.

As a result of the staircase in the frequency domain 102, the test signal 100 has a power spectrum 103 which takes the form of a series of spikes positioned at respective frequency steps, as shown.

In a second example, shown by FIG. 2b, amplitude windowing is applied to a second test signal 200 to provide a series of pulses 201, and the second test signal 200 may be otherwise identical to the first test signal 100. That is, the test signal 200 is still provided with a periodic step increase in the frequency domain 202 such that successive pulses have different frequencies, wherein a later pulse has a higher frequency. Providing the test signal 200 as a series of pulses in this way improves frequency domain crosstalk and allows more efficient multiplexing of the signals in the frequency domain. As with a first test signal 100 shown in FIG. 2a, the frequency of the test signal 200 increases with a fixed temporal pitched and fixed height staircase in the frequency domain 202, wherein the frequency staircase increases until the round-trip transit time for the fibre 1000 being interrogated is reached where the staircase is reset and starts over. If the modulator 20 has insufficient bandwidth to allow the staircase in the frequency domain 202 to fill the entire round-trip transit time for the fibre 1000, the amplitude of the test signal 200 is modulated to zero for the remainder of the pulse interrogation period before the pulse is reset and repeated for the next interrogation of the fibre 1000.

As a result of the staircase in the frequency domain 202, the test signal 200 has a power spectrum 203 which takes the form of a series of spikes positioned at respective frequency steps, as shown.

For the first test signal 100 and the second test signal 200, the pitch of the staircase in the respective frequency domains 102, 202 (i.e., the temporal pitch, or the time between increases in frequency) sets the spatial resolution for the DAS system (in particular, the spatial resolution at the section of the optical path 1000 which is probed with increased SNR), and so is akin to the gauge-length in a conventional OTDR-based DAS. An operator of a DAS system according to an embodiment of the present invention may thereby achieve a predetermined or desirable spatial resolution by setting a corresponding temporal pitch for the frequency staircase in the test signal. For example, the frequency staircase may have a pitch in the range of 50 ns-100 ns, giving a spatial resolution around 5 m-10 m.

For the first test signal 100 and the second test signal 200, the step height of the staircase in the respective frequency domains 102, 202 (i.e., the frequency increase at each step) is related to the spacing, in the frequency domain of the output signal, between interference terms (that is, the components representing interference between the scattered signal and the local oscillator signal). An operator of the DAS system according to an embodiment of the present invention may thereby separate the interference terms in the output signal to minimise spectral overlap or crosstalk by setting a corresponding step height for the frequency staircase in the test signal. (Note that each step makes an interference term between the steps in the TX and corresponding step higher and lower in the LO, such that care must be taken to choose frequencies where these interference terms are separable; an example is described below).

By way of example, a test signal (e.g., the first test signal 100 or the second test signal 200) may comprises a periodic step increase in frequency (a frequency staircase) wherein the frequency increases by 500 MHz with each step, with a pitch of 64 ns between successive increases in frequency. Where the test signal is pulsed (e.g., as the second test signal 200), each pulse may have a width of 40 ns. Such a configuration of the test signal allows 200 steps within a 100 GHz bandwidth modulation.

FIG. 3 shows a series of graphs representing a local oscillator field 300 in an embodiment of the present invention.

As can be seen in FIG. 3, the local oscillator signal 300 comprises a periodic step increase in frequency to provide a staircase in the frequency domain 301. The frequency staircase 301 of the local oscillator signal 300 has the same pitch as the frequency staircase 101 of a test signal (e.g., test signal 100), but is offset in each of a time domain and a frequency domain. As a result of the frequency staircase 301, the local oscillator signal 300 has a power spectrum 302 which takes the form of a series of spikes, wherein those spikes are offset from the power spectrum of a test signal (e.g., power spectrum 103).

The difference in frequency between the local oscillator signal 300 and a test signal allows the interference terms between each of the steps in the scattered signal and the local oscillator signal 300 to be separated in the frequency domain. For example, the local oscillator field 300 may be separated from the test signal 100 in the frequency domain by FDelta, e.g., by around 300 MHz. The time delay, TDelta, between the test signal and the local oscillator signal 300 sets the spatial location along the test path (e.g., along the fibre under test 1000) at which the inband interference and mixdown between the scattered signal and the local oscillator signal 300 occurs. An operator of a DAS system according to an embodiment of the present invention may therefore select a location for interrogation at a higher SNR (the location of the acoustic zoom analysis) by setting a corresponding time delay between the test signal and the local oscillator signal.

As described above, each of the test signal and the local oscillator signal comprise respective staircases in the frequency domain. As a result, there are components existing at a fixed pitched at F_{LO1}, F_{LO2}, F_{LO3} . . . . F_{LOn} forming the local oscillator signal, and the scattered signal fields at F_{TX1}, F_{TX2}, F_{TX3} . . . F_{TXn} (i.e., a scatter signal from each pitch of the frequency staircase).

After interference (e.g., at a square law detector as described above), additional terms are generated. Interference terms of the output signal exist at the difference between the n^{th} step in the local oscillator field and the m^{th} step in the scattered signal field. Interference terms between the local oscillator field and the terms in the scattered signal field which are lower in frequency are defined by F_{LO(n+m)}-F_{TXn}, where m is a number from 0 . . . N_{carriers}, where N_{carriers} is the number of carriers recovered by the system, given by the detection bandwidth divided by the step height (e.g., typical detected bandwidths of the order of 4 GHz would be practical, such that when the frequency increase in the staircase is 500 Hz as described above we have Ncamers=8). These carriers carry the cumulative phase to a point that is at a position z+m, where z is the position chosen by the delay offset of the local oscillator signal, as described above.

A second set of carriers is also yielded by considering the interference between the local oscillator field and the terms in the scattered signal field which are higher in frequency, and these are defined by F_{TX(n+m)}-F_{Lon}. These carriers similarly carry the cumulative phase at a position z−m, where m>1.

FIG. 4 is a graph 400 of power against frequency representing the field components due to interference of a scattered signal and a local oscillator field in an embodiment of the present invention, showing the interference terms as described above. The interference terms shown by the graph 400 are given in table 1 below. It will be appreciated that the graph 400 does not show all of the interference terms which may be present, but a sample is shown by way of example.

TABLE 1

| Term | Frequency |
|---|---|
| 401 | F_{TX(n+1)}-F_{LOn} |
| 402 | F_{LOn}-F_{TXn} |
| 403 | F_{TX(n+2)}-F_{LOn} |
| 404 | F_{LO(n+1)}-F_{TXn} |
| 405 | F_{TX(n+3)}-F_{LOn} |
| 406 | F_{LO(n+2)}-F_{TXn} |
| 407 | F_{TX(n+4)}-F_{LOn} |
| 408 | F_{LO(n+3)}-F_{TXn} |

Various examples of signals which may be used to provide typical DAS functionality (that is, functionality allowing the nature of the acoustic environment along the whole length of the optical path to be derived) in addition to the acoustic zoom functionality as described above will now be described.

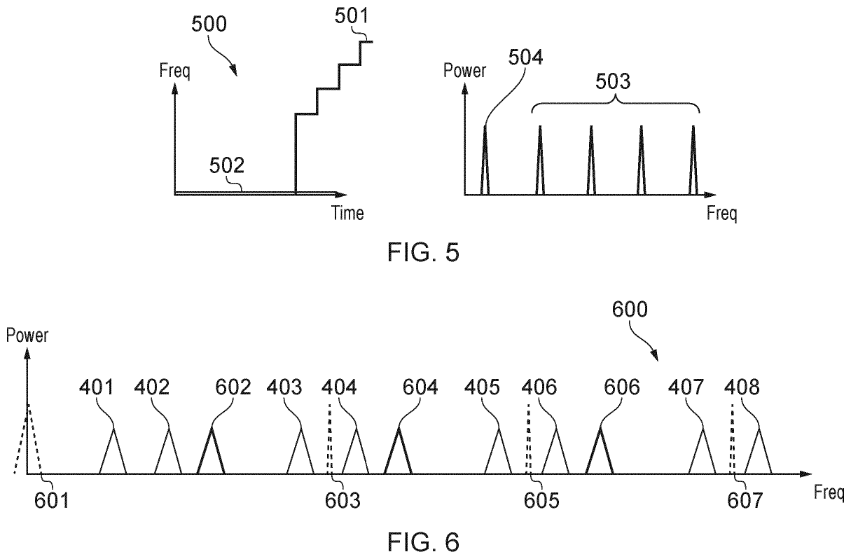

FIG. 5 shows a series of graphs representing a local oscillator field 500 which comprises a local oscillator signal comprising a periodic step increase in frequency 501 (e.g., in a manner similar to that described above with respect to FIG. 3) and a CW local oscillator signal 502. The local oscillator field 500 may be used with a test signal as described above with respect to FIGS. 2a and 2b, for example, to provide a DAS system according to an embodiment of the present invention in which both typical DAS functionality and acoustic zoom functionality is provided.

The frequency staircase local oscillator signal 501 may have similar characteristics to the local oscillator signal described above with respect to FIG. 3, for example. In particular, the frequency staircase local oscillator signal 501 has a frequency which increases periodically with a fixed pitch, and is offset from a test signal (e.g., a test signal as described above with respect to FIG. 2a or 2b) in each of a time domain and a frequency domain.

In addition to this, the local oscillator field 500 comprises a CW component 502 which is at a fixed frequency. This is a first example of a signal which may be used to provide typical DAS functionality in addition to the acoustic zoom functionality as described above.

A power spectrum (i.e., power against frequency) for the local oscillator field 500 is shown in the rightmost subfigure of FIG. 5 and comprises a series of series of spikes 503 representing the frequency staircase local oscillator signal 501, wherein each spike is positioned at a frequency of a respective frequency step in the staircase. The power spectrum also comprises a single spike 504 at the frequency of the CW local oscillator signal 502.

The resulting interference between a local oscillator field as described above with respect to FIG. 5 and a scattered signal resulting from a test signal as described above with respect to FIG. 2b will now be considered, by way of example of the principles of the present invention.

As described above, each of the test signal 200 and the local oscillator signal 500 comprise respective staircases in the frequency domain, and the local oscillator signal 500 comprises an additional, fixed-frequency CW component. As a result, there are components existing at a fixed pitched at F_{LO1}, F_{LO2}, F_{LO3} . . . F_{LOn} forming the frequency staircase local oscillator signal, a component F_{DAS_LO} for the CW local oscillator signal, and the scattered signal fields at F_{TX1}, F_{TX2}, F_{TX3} . . . F_{TXn} (i.e., a scatter signal from each pitch of the frequency staircase).

When these signals are interfered (e.g., at a square law detector as described above), terms additional to those described previously are generated. As described previously (e.g., with respect to FIG. 4), these terms may be processed in accordance with known techniques in order to extract differential strain information about the optical fibre. In addition to the determination of the strain information at a greater SNR for a particular region of interest along the optical path due to the use of the frequency stepped test signal and local oscillator signal, interference between the CW local oscillator field and the scattered field from each step of the staircase in the test signal field creates interference components (or carriers) which carry strain information about the whole length of the optical path, thereby allowing conventional DAS analysis to be performed, allowing the differential strain information to be recovered for the entire fiber length. An acoustic zoom effect for at least a portion of the optical fibre may therefore be achieved in addition to determining the differential strain environment for the entirety of the optical fibre.

As previously described, interference terms of the output signal exist at the difference between the n^{th} step in the frequency stepped local oscillator field and the m^{th} step in the scattered signal field. Interference terms between the frequency stepped local oscillator field and the terms in the scattered signal field which are lower in frequency are defined by F_{LO(n+m)}-F_{TXn}, where m is an interfere from 0 . . . N_{carriers}, where N_{carriers} is given by the detection bandwidth divided by the step height (e.g., N_{carriers}=8, as explained above, for a typical detection bandwidth of the order of 4 GHZ). These carriers carry the cumulative phase to a point that is at a position z+m, where z is the position chosen by the delay offset of the frequency stepped local oscillator signal, as described above.

A second set of carriers is also yielded by considering the interference between the frequency stepped local oscillator field and the terms in the scattered signal field which are higher in frequency, and these are defined by F_{TX(n+m)}-F_{Lon}. These carriers similarly carry the cumulative phase at a position z−m, where m>1. These first and second sets of carriers may be referred to as acoustic zoom carriers, as they may be processed to investigate the differential strain of a fibre at a particular section with an increased SNR.

A third set of carriers is also yielded by considering the interference between the CW local oscillator field and the terms of the scattered signal field, and these are defined by F_{TXn}-F_{DAS_LO}. These carriers are modulated by the cumulative phase experience up to a position defined by the time at which the sample was measured after the launch of each element (i.e., each frequency step) of the transmitted signal. This can be down-converted and processed as a normal DAS carrier (i.e., yielding differential strain information for the whole length of the optical path, though at a lower SNR than the acoustic zoom carriers described above).

Finally, there are terms created by interference between the frequency stepped local oscillator signal and the CW local oscillator signal, and these are defined by F_{LOn}-F_{DAS_LO}. These carriers are modulated by the difference in phase between the frequency stepped local oscillator signal and the CW local oscillator signal. These phase terms are fixed and create a phase offset term. By choosing the frequency offset of the CW local oscillator signal, these carriers can be positioned away from the first, second and third sets of carriers described above, and so spectral overlap can be avoided to ensure that acoustic zoom DAS and conventional DAS signals can be processed accordingly.

FIG. 6 is a graph 600 of power against frequency representing the field components due to interference of a scattered signal, a frequency stepped local oscillator signal and a CW local oscillator signal in an embodiment of the present invention, showing the interference terms described above. The interference terms shown by the graph 600 are given in Table 2 below. It will be appreciated that the graph 600 does not show all of the interference terms which may be present, but is shown by way of example. It will also be appreciated that the first set of carriers and the second set of carriers described are the same as those described above with respect to FIG. 4 and shown in Table 1, and so these terms are not repeated in Table 2.

TABLE 2

| Term | Frequency |
|---|---|
| 601 | DC terms from |
| | intrapulse |
| | interference |
| 602 | F_{TX1}-F_{DAS}_{_{—}}_{LO} |
| 603 | F_{LO1}-F_{DAS}_{_{—}}_{LO} |
| 604 | F_{TX2}-F_{DAS}_{_{—}}_{LO} |
| 605 | F_{LO2}-F_{DAS}_{_{—}}_{LO} |
| 606 | F_{TX3}-F_{DAS}_{_{—}}_{LO} |
| 607 | F_{LO3}-F_{DAS}_{_{—}}_{LO} |

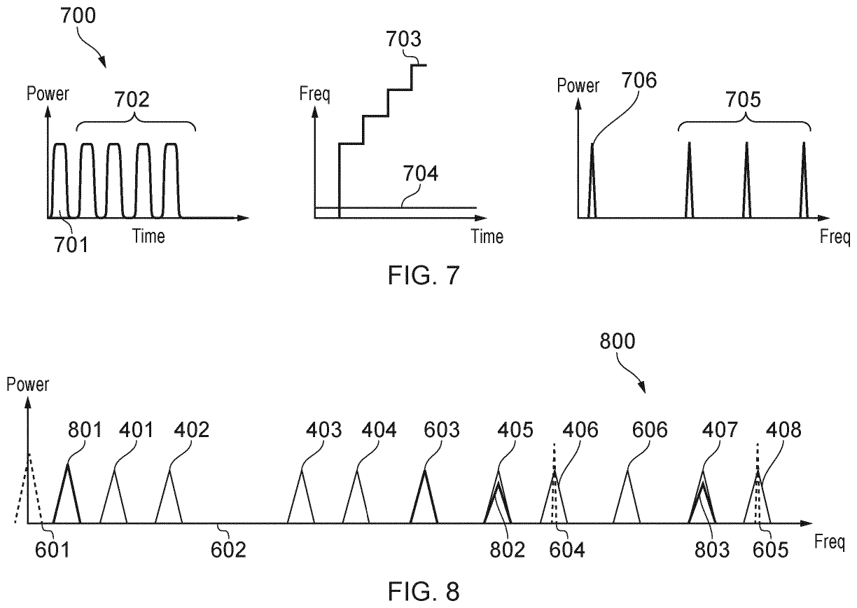

FIG. 7 shows a series of graphs representing a transmitted laser pulse, or test signal 700, in an embodiment of the present invention which may be used to perform conventional DAS analysis as well as acoustic zoom DAS analysis.

The test signal 700 is amplitude windowed to provide a series of pulses 701, 702, with a first pulse 701 providing a conventional DAS test signal with a fixed frequency 704, and a series of pulses 702 wherein successive pulses have different frequencies, wherein a later pulse has a higher frequency. That is, the series of pulses 702 have a periodic step increase in frequency, shown in the frequency domain 703. As with the test signals described above with respect to FIG. 2, the frequency staircase 703 increases with a fixed pitched and fixed height staircase, wherein the frequency staircase 703 increases until the round-trip transit time for the fibre 1000 being interrogated is reached where the staircase is reset and starts over. If the modulator 20 has insufficient bandwidth to allow the staircase in the frequency domain 703 to fill the entire round-trip transit time for the fibre 1000, the amplitude of the stepped test signal 702 is modulated to zero for the remainder of the pulse interrogation period before the pulse is reset and repeated for the next interrogation of the fibre 1000.

The power spectrum (i.e., power against frequency) is also shown in FIG. 7, and comprises a series of spikes 705 positioned at respective frequency steps for the frequency stepped test signal 702, and a single spike 706 at the frequency of the conventional DAS test signal.

The resulting interference between a local oscillator field as described above with respect to FIG. 5 and a scattered signal resulting from a test signal as described above with respect to FIG. 7 will now be considered, by way of example of the principles of the present invention.

As described above, each of the test signal 700 and the local oscillator signal 500 comprise respective staircases in the frequency domain, and an additional, fixed-frequency CW component. As a result, there are components existing at a fixed pitched at F_{LO1}, F_{LO2}, F_{LO3} . . . F_{LOn} forming the frequency staircase local oscillator signal, a component F_{DAS_LO} for the CW local oscillator signal, a component F_{DAS_TX} for the scatter from the CW test signal component, and the scattered signal fields at F_{TX1}, F_{TX2}, F_{TX3} . . . F_{TXn} (i.e., a scatter signal from each pitch of the frequency staircase).

When these signals are interfered (e.g., at a square law detector as described above), terms in addition to those described previously are generated. As described previously (e.g., with respect to FIG. 4), these terms may be processed in accordance with known techniques in order to extract differential strain information about the optical fibre. In addition to the determination of the differential strain information at a greater SNR for a particular region of interest along the optical path due to the use of the frequency stepped test signal and local oscillator signal, interference between the CW local oscillator field and the scattered field from each step of the staircase in the test signal field creates interference components (or carriers) which carry differential strain information about the whole length of the optical path, thereby allowing conventional DAS analysis to be performed. An acoustic zoom effect for at least a portion of the optical fibre may therefore be achieved in addition to determining the differential strain environment for the entirety of the optical fibre. Many of these carriers are the same as those described above with respect to FIG. 6, but there are also further carriers resulting from the additional transmitted pulse 701.

As previously described, interference terms of the output signal exist at the difference between the n^{th} step in the frequency stepped local oscillator field and the m^{th} step in the scattered signal field. Interference terms between the frequency stepped local oscillator field and the terms in the scattered signal field which are lower in frequency are defined by F_{LO(n+m)}-F_{TXn}, where m is an interfere from 0 . . . N_{carriers}, where N_{carriers} is given by the detection bandwidth divided by the step height (e.g., N_{carriers}=8, as explained above for a typical detection bandwidth of the order of 4 GHZ). These carriers carry the cumulative phase to a point that is at a position z+m, where z is the position chosen by the delay offset of the frequency stepped local oscillator signal, as described above.

A second set of carriers is also yielded by considering the interference between the frequency stepped local oscillator field and the terms in the scattered signal field which are higher in frequency, and these are defined by F_{TX(n+m)}-F_{Lon}. These carriers similarly carry the cumulative phase at a position z−m, where m>1.

These first and second sets of carriers may be referred to as acoustic zoom carriers, as they may be processed to investigate the differential strain of a fibre at a particular section with an increased SNR.

A third set of carriers is also yielded by considering the interference between the CW local oscillator field and the terms of the scattered signal field, and these are defined by F_{TXn}-F_{DAS_LO}. These carriers are modulated by the cumulative phase experienced up to a position defined by the time at which the sample was measured after the launch of each element (i.e., each frequency step) of the transmitted signal. This can be down-converted and processed as a normal DAS carrier (i.e., yielding the differential strain information for the whole length of the optical path, though at a lower SNR than the acoustic zoom carriers described above).

There is also now a carrier at a frequency of F_{DAS_TX}-F_{DAS_LO}, created from the interference between the CW local oscillator field and the scatter from the conventional DAS test pulse signal. This carrier is modulated by the cumulative phase experiences up to a position defined by the time at which the sample was measured after the launch of the test signal. It can be down converted and processed, for example as described herein, based on modifications of the applicant's earlier applications published as GB 2588177 A and GB 2609641 A (the entirety of which are incorporated herein by reference). By processing this carrier in addition to the third set of carriers as described above, the conventional DAS processing may be provided with an increased SNR.

There are also other carriers which need to be accounted for when processing the output signal. Interference between the CW local oscillator field and the frequency stepped local oscillator field themselves creates a cross term signal at F_{LOn}-F_{DAS_LO} (as also described above with respect to FIG. 6). These carriers are modulated by the difference in phase between the frequency stepped local oscillator signal and the CW local oscillator signal. These phase terms are fixed and create a phase offset term but exist at the same frequency as the positive offset position acoustic zoom carriers as described above. Additional cross terms are created by the interference between the scattered acoustic zoom (i.e., frequency stepped) test signal and the CW local oscillator field, and these exist at F_{TXn}-F_{DAS_LO}, which are coincident with the negative offset acoustic zoom carriers described above. These carriers are modulated by the scatter field and thus create a time dependent phase noise term and act as a noise source in the acoustic zoom carrier phase. In order to reduce or eliminate this effect, the frequency stepped test signal field and frequency stepped local oscillator field can be offset in frequency in order to produce a guard band, allowing the interference terms in the lower guard band to be generated without spectral overlap from the cross terms. In order to generate a guard band to ensure the acoustic zoom carriers do not interfere with the DAS carriers, the initial starting frequency of the staircases for both the transmitted test signal and the local oscillator staircase are increased. In this example an additional 1 GHz shift is added,

FIG. 8 is a graph 800 of power against frequency representing the field components due to interference of a scattered signal (generated from a test signal comprising a frequency stepped test signal field and a CW test signal field) and a local oscillator signal (comprising a frequency stepped local oscillator field and a CW local oscillator field) in an embodiment of the present invention, showing the interference terms described above. The interference terms shown by the graph are given in Table 3 below. It will be appreciated that the graph 800 does not show all of the interference terms which may be present, but is shown by way of example. It will also be appreciated that some of the carriers described are the same as those described above with respect to FIG. 4 and FIG. 6, and shown in Table 1 and Table 2, and so these terms are not repeated in Table 3.

TABLE 3

| Term | Frequency |
|---|---|
| 801 | F_{DAS}_{_{—}}_{TX}-F_{DAS}_{_{—}}_{LO} |
| 802 | F_{LO1}-F_{DAS}_{_{—}}_{TX} |
| 803 | F_{LO2}-F_{DAS}_{_{—}}_{TX} |

### Signal Processing

Distributed acoustic sensing systems according to embodiments of the present invention are described above. Descriptions of signal processing methods which may be used with such embodiments are described below.

Generally, the processing methods described herein are based on those described in the applicant's earlier applications published as GB 2588177 A and GB 2609641 A (the entirety of which are incorporated herein by reference), though modifications are required in order to include the addition of signals from multiple carriers (e.g., as described above with references to FIGS. 4, 6, and 8). The modifications are required to account for the multiple sets of carriers described above and, for the acoustic zoom channel, because of the different information the acoustic zoom carriers contain as a function of time (described in more detail below), allowing the acoustic field to be reconstructed without distortion.

As described above, in embodiments of the present invention, the local oscillator signal and, optionally, the test signal may be configured to provide conventional DAS functionality in addition to acoustic zoom DAS functionality (e.g., by providing a CW local oscillator field in addition to the frequency stepped local oscillator field). When processing the output signal, separate processing paths are required for the conventional DAS functionality and the acoustic zoom DAS functionality. The acoustic zoom DAS processing path may therefore be implemented separately (e.g., in embodiments of the present invention wherein only acoustic zoom DAS functionality is to be provided).

### Acoustic Zoom Channel Processing

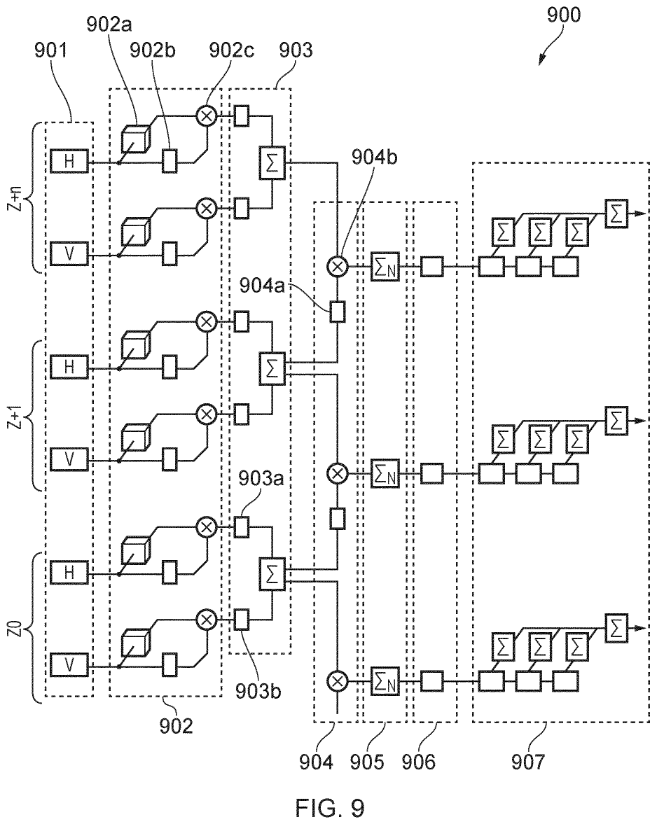

FIG. 9 is a schematic diagram showing an example signal processing method 900 for the acoustic zoom channel of an output signal (e.g., an output signal received from a DAS system according to an embodiment of the present invention). The steps of the method may be carried out by a controller of the system having appropriate software and/or firmware installed thereon. In some cases, the controller may be implemented by a field-programmable gate array (FPGA).

As described previously, interference terms between the frequency stepped (acoustic zoom) local oscillator field and the terms in the scattered field lower in frequency are defined by F_{LO(n+m)}-F_{TXn} where m is an integer from 0 . . . N_{AZCarriers}. These carriers carry the cumulative phase to the point that is at a position z+m·Δz, where z is the position chosen by the delay offset of the frequency stepped local oscillator field relative to the test signal and Δz is the spatial pitch of the staircase. A second set of carriers is also yielded by considering the interference between the local oscillator signal and the terms in the scattered field higher in frequency, defined by F_{TX(n+m)}-F_{LOn}. These carriers again carry the cumulative phase at a position z−m·Δz; m>1 in this case. The difference between these carriers and the conventional DAS carriers is the information they carry as a function of time. At timescales less than the pulse repetition frequency (PRF), a conventional DAS carrier shows the cumulative phase modulation on the fibre as a function of location, i.e., the time delay directly maps to location. The acoustic zoom carrier however shows the cumulative phase modulation on the fibre starting from the chosen location set by the time delay between the frequency staircase test signal and the frequency staircase local oscillator signal. As a function of time, as with the conventional DAS carrier, the acoustic zoom carrier shows the cumulative phase modulation as a function of position. However, this is only valid up to a time delay equal to the pitch of the frequency staircase. Once the temporal pitch of the frequency staircase is exceeded, the carrier steps back and again carries the cumulative phase modulation acting on the fibre from the chosen location but sampled a short time later. Note, however, that this interrogation is at a different optical frequency and the coherent scatter between steps in the frequency staircase test signal is uncorrelated. The phase bias of the carrier therefore jumps to a random value on each step in the frequency staircase test signal. As with combinations of different polarisation states, the phase bias must be aligned to a common axis or removed prior to combination. This repeats for each step in the frequency staircase test signal. This therefore may result in hundreds (in some examples) of short sections of phase modulation in time up to the PRF period where the pattern repeats. FIG. 9 shows a proposed signal processing scheme that allows the acoustic zoom carrier to yield a spatial differential of the phase modulation for several locations either side of the chosen delayed location but with much higher SNR when compared to the conventional DAS carrier results.

In a first stage of processing 901, an output from an analog-to-digital converter (e.g., ADC 42a, 42b) is passed to a digital down converter (DDC), which may perform any suitable processes to generate a first complex carrier signal from the output of the ADC. As an example, the output of the ADC may be split into two parts, with one part being multiplied by an in-phase component (cos ωt) and one part being multiplied by a quadrature component (−sin ωt). This has the effect of shifting the carrier signal down, such that the desired positive frequency term is centred at DC. Each of these parts may then be passed through a respective lowpass filter to remove the unwanted terms, and the outputs of the lowpass filters are recombined into a complex signal, which is a first complex carrier signal. A DDC is present for each acoustic zoom carrier (i.e., carriers Z−n . . . Z−1, Z0, Z+1 . . . Z+n; but only Z0, Z+1 and Z+n are shown in FIG. 9 for clarity) and for each polarisation state (i.e., each of the vertical (V) and horizontal (H) polarisation states, as described above with respect to in FIG. 1).

Then, in a second stage 902, a carrier modulated by the temporal instantaneous frequency (IF) of the cumulative phase is defined over the period of the PRF. This is achieved by taking a copy of the first complex carrier signal, applying a time delay (at step 902a) to the copy (wherein the time delay is equal to the round-trip transit time, or the time between successive test signals), taking the complex conjugate of an un-delayed first complex carrier signal (at step 902b), then cross-multiplying the delayed copy with the un-delayed complex conjugate (at step 902c). It will be appreciated that this processing is performed for each polarisation state (i.e, horizontal, H, and vertical, V) of each acoustic zoom carrier (i.e., carriers Z−n . . . Z−1, Z0, Z+1 . . . Z+n).

The signals for each acoustic zoom channel from each polarisation state are then combined at stage 903 to yield a polarisation stacked acoustic zoom carrier (i.e., a carrier which contains information relating to each of the horizontal and vertical polarisation states). A weighting may be applied to each polarisation state prior to combination, at steps 903a, 903b, to ensure optimal stacking at later processing stages to maximise a final SNR.

In order to generate a spatial differential signal for a given location (in particular, at a location defined between adjacent frequency step pitches), the interference between each of the acoustic zoom channels needs to be considered. Therefore, at a fourth stage 904 the IF carrier for a location Z(n) is multiplied (at step 904b) with the complex conjugate (generated at step 904a) of the IF carrier for the adjacent location Z(n+1). This is done for each spatially adjacent pair of acoustic zoom carriers, yielding a complex carrier which is modulated by the spatial differential of the IF of the cumulative phase. If a gauge length exceeding the spatial/temporal pitch of the staircase is required this could be achieved by taking the differential between non-adjacent acoustic zoom carriers to yield a gauge length an integer number of spatial/temporal pitches in length/duration.

After the fourth stage 904, spatial stacking for each location within the pitch of the frequency stepped test signal is now possible, at the fifth stage 905. Adjacent samples of the carrier are summed together in the fifth stage 905, each sample corresponding to scatter signals that were scattered from adjacent locations.

A rectangular-to-polar (RP) transform is then applied to the stacked signals at a sixth stage 906, to produce a signal that is representative of the IF (i.e., the rate of change of the spatial differential of the phase difference). In order to determine a value representative of the time differential of the spatial differential of phase for each of the respective locations along the optical path, separate channel processing is performed at a seventh stage 907 to integrate the IF in time. In order to recover the phase of the acoustic field which is affecting the optical path, a sum over time is performed, this is a sum of the time differential of the spatial differential of phase for each position over time as each pulse of light is launched along the optical path and processed.

In particular, this results in several channels of data, each showing the spatial differential of the phase modulation sampled at a different offset time. If the frequency staircase were as long as the PRF then this time delay would need to be accounted for prior to stacking in the fifth stage 905; however, if the acoustic frequency of interest (i.e., the frequency modulating the optical path), then all the temporal channels may be stacked to yield a single acoustic data stream with a sampling rate of the PRF. Since this is now an average of all samples taken within the PRF, this channel will have a much higher SNR than a conventional DAS system.

### Conventional DAS Channel Processing

The inventors have found that the signal processing methods described in previous applications GB 2588177 A and GB 2609641 A may be modified in order to provide acoustic zoom and/or conventional DAS sensing in a manner which is capable of handling the additional carriers which result from the use of a test signal which comprises frequency steps, and which allows the acoustic field modulating the optical path to be reconstructed without distortion.

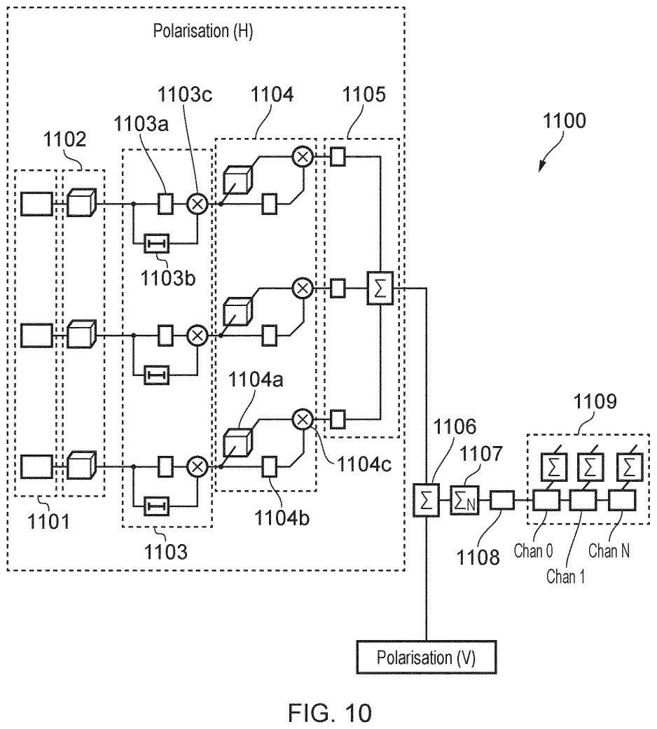

FIG. 10 is a schematic diagram showing an example signal processing method 1100 for the conventional DAS channel of an output signal (e.g., an output signal received from a DAS system according to an embodiment of the present invention). The steps of the method may be carried out by a controller of the system having appropriate software and/or firmware installed thereon. In some cases, the controller may be implemented by a FPGA.

The signal processing method 1100 recovers the DAS signal from several conventional DAS carriers (e.g., as described above with respect to FIGS. 6 and 8) and combines these signals into a single DAS data stream.

As described above, a set of carriers defined by F_{TXn}-F_{DAS_LO} are modulated by the cumulative phase experienced up to a position defined by the time at which the sample was measured after the launch of each element (i.e., each frequency step) of the transmitted signal. This can be down-converted and processed as a normal DAS carrier (i.e., yielding the differential strain information for the whole length of the optical path, though at a lower SNR than the acoustic zoom carriers described above). It is these carriers which are therefore taken as an input to the signal processing method 1100. In a first stage of processing 1101, an output from an analog-to-digital converter (e.g., ADC 42a, 42b) is passed to a digital down converter (DDC), which may perform any suitable processes to generate a first complex carrier signal from the output of the ADC. As an example, the output of the ADC may be split into two parts, with one part being multiplied by an in-phase component (cos ωt) and one part being multiplied by a quadrature component (−sin ωt). This has the effect of shifting the carrier signal down, such that the desired positive frequency term is centred at DC. Each of these parts may then be passed through a respective lowpass filter to remove the unwanted terms, and the outputs of the lowpass filters are recombined into a complex signal, which is a first complex carrier signal. A DDC is present for each conventional DAS carrier (i.e., carriers F_{TX1}-F_{DAS_LO} to F_{TXn}-F_{DAS_LO}) and for each polarisation state (i.e., each of the vertical (V) and horizontal (H) polarisation states, as described above with respect to in FIG. 1; only the horizontal polarisation is shown in detail in FIG. 10, for clarity).

Since each carrier is generated by a different step in the frequency staircase test signal, generated at a time delay relative to the previous steps, a second stage 1102 comprises aligning the temporal delay between the carriers. This temporal delay is n times the pitch of the staircase, wherein n is the index of the carrier (i.e., from 1 to Ncarriers).

At a third stage 1103, a carrier is generated which carries the spatial differential of the phase. This is achieved by generating a complex conjugate of the carrier (step 1103a), delaying a copy of the original carrier by a predetermined gauge length (step 1103b) and multiplying the complex conjugate with the delayed copy (step 1103c).

Before the different carriers can be stacked (or summed), the phases need to be aligned, by removing phase bias. One method of doing this is to generate a carrier which is modulated by the time differential of the spatial differential of the phase modulation. This is done at a fourth stage 1104. In particular, in the fourth stage 1104 a copy of the first complex carrier signal is created, a time delay is applied (at step 1104a) to the copy (wherein the time delay is equal to the round-trip transit time, or the time between successive test signals), the complex conjugate of an un-delayed first complex carrier signal is taken (at step 1104b), then these are cross-multiplied (at step 1104c), generating a carrier modulated by the instantaneous frequency (IF) of the phase modulation.

At a fifth stage 1105, the output from all of the conventional DAS carriers are combined for each polarisation state, and the signals from each polarisation state are combined again at a sixth stage 1106. After the sixth stage 1106, adjacent samples of the carrier are summed together in the seventh stage 1107 to perform spatial stacking, each sample corresponding to scatter signals that were scattered from adjacent locations.

A rectangular-to-polar (RP) transform is then applied to the stacked signals at an eighth stage 1108, to produce a signal that is representative of the IF (i.e., the rate of change of the spatial differential of the phase difference). In order to determine a value representative of the time differential of the spatial differential of phase for each of the respective locations along the optical path, separate channel processing is performed at a ninth stage 1109 to integrate the IF in time. In order to recover the phase of the acoustic field which is affecting the optical path, a sum over time is performed, this is a sum of the time differential of the spatial differential of phase for each position over time as each pulse of light is launched along the optical path and processed.

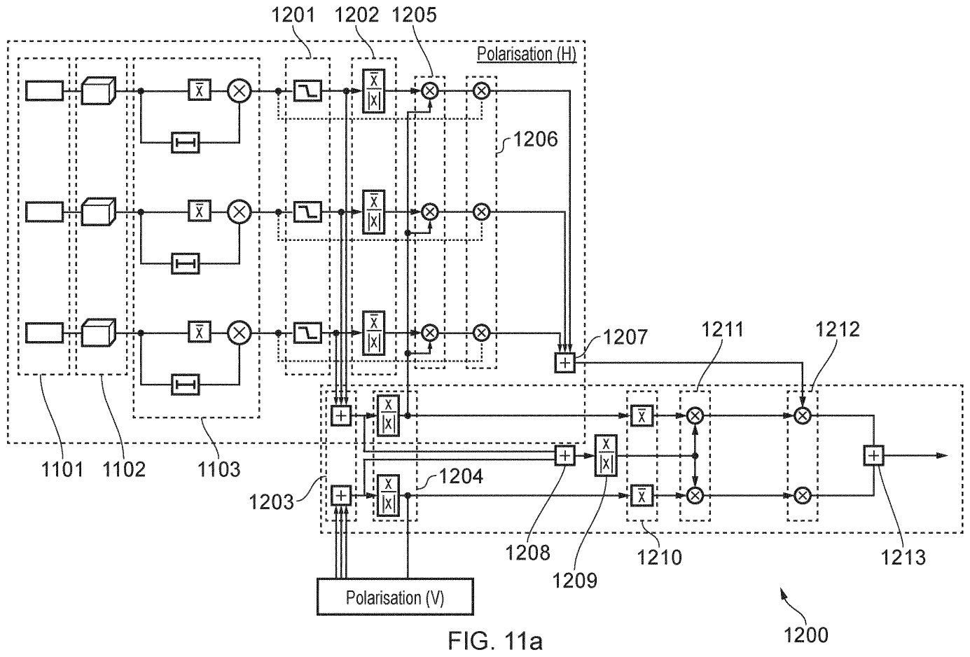

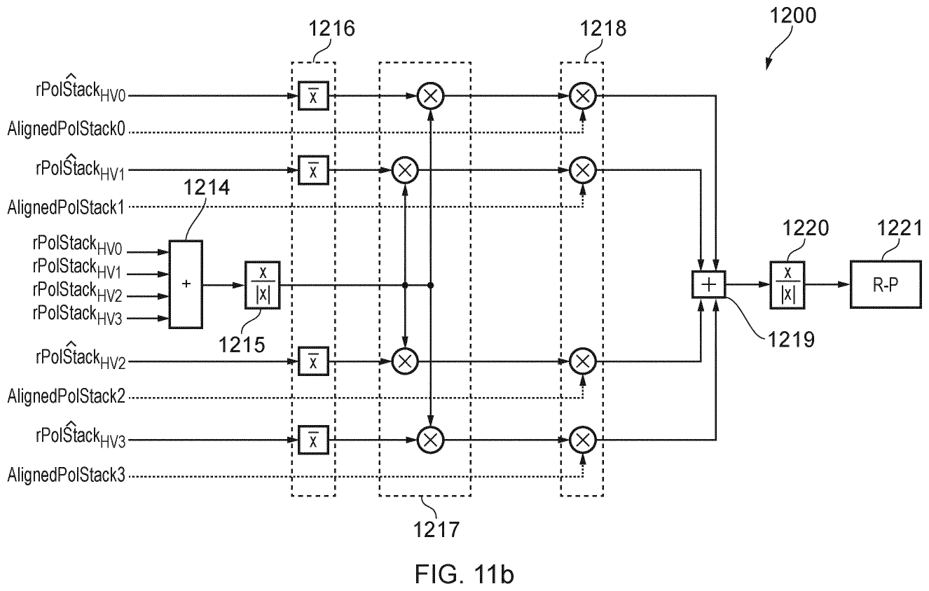

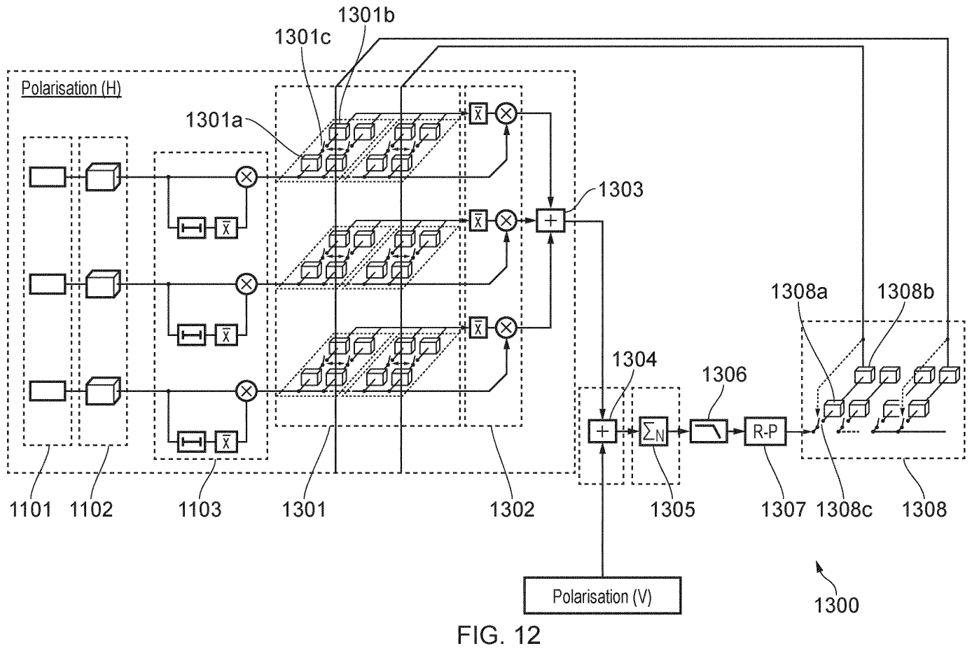

It may be noted that FIG. 10 is a similar processing method to that described above with respect to FIG. 9 for the acoustic zoom channel. Similarly, the processing methods for a convention DAS channel described below with respect to FIGS. 11 and 12 may be modified in a likewise manner in order to provide processing methods suitable for an acoustic zoom channel.

FIGS. 11(a) and 11(b) are schematic diagrams showing a second example signal processing method 1200 for the conventional DAS channel of an output signal (e.g., an output signal received from a DAS system according to an embodiment of the present invention). The steps of the method may be carried out by a controller of the system having appropriate software and/or firmware installed thereon. In some cases, the controller may be implemented by a FPGA. For example, the second method 1200 may be used as an alternative to the method 1100 described above with respect to FIG. 10.

The signal processing method 1200 recovers the DAS signal from several conventional DAS carriers (e.g., as described above with respect to FIGS. 6 and 8) and combines these signals into a single DAS data stream.

The second method 1200 receives, as described above, a set of carriers defined by F_{TXn}-F_{DAS_LO} which are modulated by the cumulative phase experienced up to a position defined by the time at which the sample was measured after the launch of each element (i.e., each frequency step) of the transmitted signal. This can be down-converted and processed as a normal DAS carrier (i.e., carrying differential strain information for the whole length of the optical path, though at a lower SNR than the acoustic zoom carriers described above). The first stages of processing are therefore similar to those stages described with respect to FIG. 10, and the second method comprises a first stage 1101 in which an output from an ADC is passed to a DDC for generating a first complex carrier signal. The second stage 1102 comprises aligning the temporal delay between the carriers, and at the third stage 1103, a carrier is generated which carries the spatial differential of the phase (this carrier may be referred to as a second complex carrier signal).

The second complex carrier signal may be represented as a phasor. In order to improve the signal-to-noise ratio prior to performing a rectangular-to-polar (RP) coordinate transform for recovering the phase information of the modulating signal, phasors for each spatial location, and for each polarisation may be stacked together. To do this, the signal processing method 1200 defines a common reference phasor and an angle through which the set of second complex carrier signals should be rotated through to be defined with respect to the reference phasor. The rotation angle is defined by an aligner vector. Such reference phasors and aligner vectors are found to allow stacking of the carriers in each polarisation state, stacking of the carriers for both polarisation states, and a final spatial stack of all carriers as described below.

First, the steps for stacking carriers in each polarisation state will be described. After the third stage 1103, the carrier is low pass filtered at a fourth stage 1201 to define a reference vector, rPolH_{N}, for each carrier. This vector is an unmodulated carrier aligned in the same direction as the phase bias on the carrier which carries the spatial differential. The vector is then normalised and the complex conjugate is taken at a fifth stage 1202. These steps are performed for all of the conventional DAS carriers in each polarisation stage. Each polarisation state is processed independently, and for each polarisation stage a common reference axis is defined onto which all of the carriers carrying the spatial differential will be aligned.

To perform this alignment, a vector sum of the reference vectors, \hat{r}PolH_{N}, is performed at a sixth stage 1203, giving a summed reference vector for each polarisation state—\hat{r}Stack_{H} and \hat{r}Stack_{V}. These reference vectors for each polarisation state are normalised and the complex conjugate taken at a seventh stage 1204 to give unit polarisation stack vectors. The unit polarisation stack vector for each polarisation state is then multiplied with each individual reference vector, rPolH_{N}, for each carrier at an eighth stage 1205 to define a second unit vector, which is the aligner vector for each carrier, \hat{r}AlignerPolH_{N}. The aligner vector takes the baseband carrier (the second complex carrier signal) and rotates it via multiplication (at a ninth stage 1206) such that it is aligned along a common bias axis (that is, common to the polarisation state) defined by the unit stack vector \hat{r}Stack_{H}. All of the vectors in each polarisation state are therefore aligned along a common axis and can therefore be stacked at a summing stage 1207 without distorting the modulation carried on each carrier. After the summing stage 1207, a common stacked carrier is therefore defined for each polarisation state, AlignedPolHComp and AlignedPolVComp.

However, since the common reference bias for each group (that is, the two polarisation states) are different, alignment of the stacked carriers must be undertaken before they can be combined. A similar process as for stacking carriers in each polarisation state is followed.

The summed reference vector for each polarisation state (\hat{r}Stack_{H} and \hat{r}Stack_{V}) are summed 1208, and the resulting sum is normalised 1209 to give a polarisation state vector, \hat{r}PoIStackH_{V}, which sets the common axis. The complex conjugate 1201 of the unit polarisation stack vector for each polarisation state is obtained, and by multiplying 1211 with the polarisation stage vector an aligner vector for each polarisation stack is obtained—\hat{r}AlignerStack_{H} and \hat{r}AlginerStack_{V} for the horizontal and vertical polarisations stacks, accordingly. The common stacked carriers for each polarisation state obtained above (AlignedPolHComp and AlignedPolVComp) are aligned by multiplication 1212 with the corresponding aligner vector for the polarisation state, and these aligned stacks are themselves summed 1213 to give a single stacked carrier for both polarisation stages, AlignedPolStack.

In some embodiments, the RP transform may be carried out based on the stacked carrier for both polarisation states. However, in other examples, a further and final stage of spatial stacking can also be performed prior to the RP transform, as shown in FIG. 11(b).

Noting, as before, that each frequency step of the received signal corresponds to a spatial location, the spatial stacking process starts by summing 1214 polarisation state stacked vectors for each spatial location (rPolStack_{HV0}, rPolStack_{HV1}, rPolStack_{HV2}, rPolStack_{HV3} etc.). This vector stack is then normalised 1215 to unit length to define a unit spatial stack vector.

The polarisation state vector for each position (\hat{r}PolStack_{HV0}, \hat{r}PolStack_{HV1}, \hat{r}PolStack_{HV2}, fPolStack_{HV3}) is conjugated 1216, and then multiplied 1217 with the unit spatial stack vector. This gives a set of aligner vectors, with an aligner vector corresponding to each spatial position. Using this aligner vector, the aligned polarisation stacks for each position (AlignedPolStack0, AlignedPolStack1, AlignedPolStack2, AlignedPolStack3) are then rotated to be aligned on a common bias axis by multiplication 1218 with the aligner vector. The resulting vectors are therefore aligned along a common axis can and can be stacked or summed 1219 and normalised 1220 prior to RP transformation 1221, which recovers the desired phase information.

FIG. 12 is a schematic diagram showing a third example signal processing method 1300 for the conventional DAS channel of an output signal (e.g., an output signal received from a DAS system according to an embodiment of the present invention). The steps of the method may be carried out by a controller of the system having appropriate software and/or firmware installed thereon. In some cases, the controller may be implemented by a FPGA. For example, the third method 1300 may be used as an alternative to the method 1100 described above with respect to FIG. 10 or the second method 1200 described above with respect to FIGS. 11(a) and 11(b).

The signal processing method 1300 recovers the DAS signal from several conventional DAS carriers (e.g., as described above with respect to FIGS. 6 and 8) and combines these signals into a single DAS data stream.

The third method 1300 receives, as described above, a set of carriers defined by F_{TXn}-F_{DAS_LO} which are modulated by the cumulative phase experienced up to a position defined by the time at which the sample was measured after the launch of each element (i.e., each frequency step) of the transmitted signal. The third method 1300 therefore comprises a processing path for each carrier. Each carrier can be down-converted and processed as a conventional DAS carrier (i.e., carrying differential strain information for the whole length of the optical path, though at a lower SNR than the acoustic zoom carriers described above). The first stages of processing are therefore similar to those stages described with respect to FIG. 10, and so the third method 1300 comprises a first stage 1101 in which an output from a ADC is passed to a DDC for generating a first complex carrier signal. The second stage 1102 comprises aligning the temporal delay between the carriers, and at the third stage 1103, a carrier is generated which carries the spatial differential of the phase. It will be appreciated that these processing stages are performed for all of the carriers in each polarisation stage.

As described above, before the different carriers can be stacked (or summed), the phase bias for each carrier needs to be aligned. For example, as described above with respect to FIG. 10, this may be done by generating a carrier which is modulated by the time differential of the spatial differential of the phase modulation, the time differential being taken at a fixed time delay equal to the round-trip transit time. Instead, in the third method 1300, However, this alignment may be achieved in various other ways, and the third method 1300 utilises a modification of a method described in GB 2609641 A.

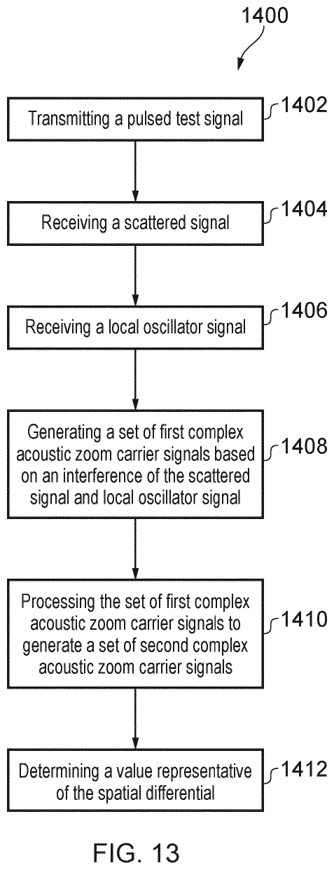

As each of the scattered signals was scattered at a respective location along the optical path, each scattered signal is considered as belonging to a respective spatial “channel” of the system. In other words, each spatial channel of the system corresponds to a respective scattering location along the optical path. The scattered signals will be received sequentially in time due to their different scattering locations along the optical path, such that each scattered signal can be assigned to its corresponding spatial channel based on its time of receipt at the detector stage. Each carrier, representing scattering from a frequency step of the transmitted signal, will therefore be associated with a number of spatial channels, as a conventional DAS carrier. The spatial channel for each carrier of the system is associated with a respective pair of memory locations 1301. Following generation of the second complex carrier signal for a given spatial channel, a copy of the second complex carrier signal is stored in a first memory location 1301a associated with that spatial channel. Thus, as a scattered signal for each spatial channel is received in turn, a second complex carrier signal is generated for that spatial channel, and a copy of the second complex carrier signal is stored in the first memory location 1301a associated with that spatial channel. If the current second complex carrier signal is the first (or initial) one generated for the spatial channel, then a copy of the second complex carrier signal is also stored in a second memory location 1301b associated with that spatial channel. As shown in FIG. 13, the first memory location 1301a and second memory location 1301b are connected via a switch 1301c, which can be closed so that the second complex carrier signal stored in the first memory location 1301a can be copied to the second memory location 1301b. The copy of the second complex carrier signal that is stored in the second memory location 1301b is subsequently used as a reference complex carrier signal for the corresponding spatial channel. Note that, in some cases, it may not be necessary to provide a dedicated memory location (i.e. the first memory location 1301a) for storing the second complex carrier signal. Instead, the second complex carrier signal may form part of a data stream that is generated by the system, and the second complex carrier signal may simply be recovered from the data stream when/if needed. The data stream may include an indication of the spatial channel associated with each second complex carrier signal in the data stream, such that the relevant second complex carrier signal can be recovered from the data stream. Thus, the second complex carrier signal associated with a given spatial channel may be obtained from the data stream, and stored as the reference complex carrier signal for that spatial channel.

The reference complex carrier signal for a spatial channel (stored in second memory location 1301b) then undergoes complex conjugation and is multiplied by the second complex carrier signal associated with that spatial channel, at a third complex carrier signal generation stage 1302. The third complex carrier signal associated with that spatial channel is thereby modulated by a phase difference between the second complex carrier signal and the reference complex carrier signal. It should be noted that other techniques may be used for generating the third complex carrier signal. As noted above, the reference complex carrier signal may correspond to a copy of an initial second complex carrier signal generated for the spatial channel. Thus, when a subsequent second complex carrier signal is generated for that spatial channel, the phase difference between the second complex carrier signal and the reference complex carrier signal effectively corresponds to an increment (or change) in the second complex carrier signal over a period of time between receipt of the initial scattered signal and the most recent scattered signal for that spatial channel. Thus, the modulation of the third complex carrier signal may effectively correspond to a time differential of the second complex carrier signal. As a result, the modulation of the third complex carrier may be indicative of a rate of change (i.e. the instantaneous frequency) of an acoustic modulation on the optical path at a location corresponding to the spatial channel.

Where the current second complex carrier signal is the first (or initial) one generated for the spatial channel, then the second complex carrier signal will effectively be multiplied by a complex conjugate of itself (as in this case the reference complex carrier signal is a copy of the current second complex carrier signal). Therefore, the initial third complex carrier signal generated for the spatial channel will be biased at zero, so that the measurement will start from zero. The modulation of subsequent third complex carrier signals generated for the spatial channel will then be indicative of a change relative to the reference complex carrier signal stored for that spatial channel.

Processing each of the spatial channels in this manner results in generation of a respective third complex carrier signal for each spatial channel. To generate a common third complex carrier signal, a sum 1303 of third complex carrier signals across all spatial channels and between each carrier channel is performed (a ‘spatial stack’), following by a second sum 1304 of the complex carrier signals for each polarisation state (a ‘polarisation stack’).

Noting that complex carrier signals may be represented as phasors, the angle of a phasor representing a third complex carrier signal may thus be related to the instantaneous frequency of the acoustic modulation for the corresponding spatial channel. So, for an unperturbed spatial channel (i.e. where there is no acoustic modulation), the phasor representing the third complex carrier signal may lie along the neutral axis. On the other hand, for a perturbed spatial channel (i.e. undergoing acoustic modulation), the angle of the phasor representing the third complex carrier signal may be proportional to the change of the acoustic modulation, but importantly the period over which this change in phase or instantaneous frequency is measured is determined by when the stored reference 1301b was last updated. In other words, phasors corresponding to unperturbed locations may be aligned along the neutral axis, whilst phasors corresponding to perturbed locations may be aligned along a common axis. The inventors have found that such an alignment of the phasors enables third complex carrier signals corresponding to scattered signals that were scattered at similar or adjacent locations to be summed constructively, thus resulting in an improved SNR.

A sum 1305 of third complex carrier signals across multiple spatial channels is performed. In particular, third complex carrier signals corresponding to two or more adjacent spatial channels are summed together, to produce a fourth complex carrier signal. For example, eight samples of the third complex carrier signal may be summed, each corresponding to scattered signals that were scattered from adjacent locations on the optical path. However, the number of third complex carrier samples that are summed together may be selected based on a desired spatial resolution of the measurement, and may also be dependent on the sampling rate, data rate and pulse length. The sum 1305 may be referred to as a ‘spatial stack’, as it corresponds to summing (stacking) signals corresponding to different locations along the optical path.

The fourth complex carrier signal may then be passed through a filter 1306, to reduce noise bandwidth. The filter 1306 may be a low pass filter that operates on the real and imaginary components of the signal (e.g. an ‘IQ’ filter). For example, the filter may be implemented using a moving average, an infinite impulse response (IIR), a finite impulse response (FIR), or any other suitable digital filter.

As noted above, the fourth complex carrier signal is generated by summing the third complex carrier signals from two or more spatial channels together. Thus, the modulation of the fourth complex carrier signal may be related to a change in the acoustic modulation relative to the current stored reference (1301b) at locations on the optical path corresponding to the two or more spatial channels. The spatial channels of the system may be split up into multiple sets of two or more spatial channels. Then, the third complex carrier signals for a set of spatial channels may be summed together in order to generate the fourth complex carrier signal for that set of spatial channels.

The fourth complex carrier signal is used to determine a value representative of the instantaneous frequency of the acoustic modulation at the corresponding scattering locations. In the example of FIG. 12, this is done by applying a rectangular-to-polar coordinate transform 1307 to the fourth complex carrier signal. Passing the fourth complex carrier signal through the rectangular-to-polar transform 1307 produces a signal that is representative of the phaser change relative to the phase of the stored reference 1301b (i.e. the rate of change of the spatial differential of the phase difference). In particular, the rectangular-to-polar coordinate transform 1307 may output an angle of a phasor that represents the fourth complex carrier signal. The angle of the phasor may be related (e.g. proportional to) the instantaneous frequency, but taken over a period since the reference (1301b) was last updated.

The method 1300 further includes a process for determining when to update the reference complex carrier signal associated with a spatial channel (i.e. stored in second memory location 1301b). This is done by analysing the value representative of instantaneous frequency that is output by the R-P transform 1307, and corresponding to the two or more spatial channels across which the spatial stack was performed, to determine whether a predetermined condition is met. If the predetermined condition is met, then the reference complex carrier signals associated with each of the two or more spatial channels are updated. Specifically, for each of the two or more spatial channels, the current second complex carrier signal (which is stored in first memory location 1301a) is copied to the second memory location 1301b to make it the new reference complex carrier signal for that spatial channel. This may be done, for example, by closing the switch 1301c, to enable the current second complex carrier signal to be copied to the second memory location 1301b. Then, when subsequent signals are processed for the two or more spatial channels, the updated reference complex carrier signals will be used to generate the third complex carrier signals.

This process is done at a final stage 1308. An initial value representative of the instantaneous frequency associated with a set of two or more spatial channels is saved in a first memory location 1308a. A switch 1308c, connected between the output of the RP transformed 1307 and the first memory location 1308a can be closed to enable the value representative of the output instantaneous frequency to be copied to the first memory location 1308a. Information related to a predetermined condition is stored in a second memory location 1308b (for example, the predetermined condition may correspond to a threshold value for the instantaneous frequency). If the predetermined condition is determined to be met for one of the sets of two or more spatial channels, then the switches 1301c associated with each of the two or more spatial channels may be closed. Additionally the switch 1308c associated with that set of two or more spatial channels may be closed. This causes, for each of the two or more spatial channels, the current second complex carrier signal to be stored as the reference complex carrier signal for that channel.

Additionally, this causes the current value of the output instantaneous frequency to be stored as the reference instantaneous frequency for the set of two or more spatial channels. Thus, the reference instantaneous frequency may be updated at the same time as the reference complex carrier signals. For instance, the angle of the instantaneous frequency output for a set of two or more spatial channels from the R-P transform 1307 may be compared to the threshold value, and if the angle of the instantaneous frequency exceeds the threshold value, then updating of the reference complex carrier signals may be triggered, e.g. by closing switches 1301c and 1308c as discussed above. For example, the inventors have found that π/2 may be a suitable threshold angle for triggering update of the reference complex carrier signals. However, other threshold values may be used, depending on desired noise characteristics of the output.

It will be appreciated that the signal processing methods described above with respect to FIGS. 10 to 12 are provided for the conventional DAS channel of an output signal, and may be performed, for example, in combination with a signal processing method for an acoustic zoom channel as also described herein. In this way, the present invention may allow a section of the optical path to be probed with a higher SNR using the acoustic zoom methods as described herein, while maintaining a conventional DAS analysis for the remainder of the optical path.

FIG. 13 is a flow chart of a signal processing method 1400 according to an embodiment of the present invention. Preferably, the signal processing method 1400 may make use of an OTDR having an acoustic zoom channel, for example as described above with respect to FIG. 1, though the detection stage may be altered as required to work with the processing methods described herein. Steps of the method may be carried out by a controller of the system having appropriate software installed thereon.

In a first step 1402, the method 1400 comprises transmitting, with a coherent light source such as a laser, a pulsed test signal along an optical path, such as the optical fiber 1000. Preferably, the coherent light source may operate in a continuous wave mode, wherein the continuous wave may be pulsed, for example using an IQ modulator, typical constructed by a cascaded arrangement of EOMs or similar as generally as described above with respect to FIG. 1. In particular, the optical path may be an optical fiber such that vibrations of the optical fiber may be detected using the method described herein. As described herein, the test signal comprises a periodic step increase in frequency (that is, the test signal comprises a series of frequency steps). For example, the test signal may be a test signal as described above with respect to FIGS. 2-8.

In a second step 1404, the method 1400 comprises receiving a scattered signal that was scattered at a location along the optical path. Preferably, the signal may be received at a detector stage, such a detection stage of an OTDR. As the test signal comprises a periodic step increase in frequency, the scattered signal comprises a corresponding step increase in frequency.

A local oscillator signal is also received by the detector stage at step 1406. For example, the detector stage may be a detector stage 50 as described above. The local oscillator signal is offset relative to the test signal in each of a time domain and a frequency domain, and also comprises a periodic step increase in frequency.

When the scattered signal and the local oscillator signal are received, the method 1400 comprises generating, based on interference of the scattered signal and the local oscillator signal, a set of first complex acoustic zoom carrier signals, at step 1408. Each first complex acoustic zoom carrier signal results from interference between a frequency step of the scattered signal and a frequency step of the local oscillator signal, and is modulated by a phase difference (in particular, a cumulative phase difference up to the location of the scattering site) between the local oscillator signal and the scattered signal, at a spatial location along the optical path determined by the time offset between the pulse test signal and the local oscillator signal, as well as the associated frequency step of the scattered signal, as described herein.

The set of first complex acoustic zoom carrier signals is then processed to generate a set of second complex carrier signals that are modulated by a spatial differential of the phase difference, the spatial differential being taken along a chosen length of the optical path. This is shown in step 1410. In particular, the second set of complex acoustic zoom carrier signals are generated based on interference between spatially adjacent first complex acoustic zoom carrier signals (for example, as described above with respect to FIG. 9).

Finally, the method 1400 comprises, at step 1412, determining, based on the second complex carrier signal, a value representative of the spatial differential of the phase difference for the location along the optical path. For example, this may be determined according to a method as described above with respect to FIG. 9.

In this way, the method 1400 provides an acoustic sensing method which allows a narrow (compared with the overall length of the optical path) set of locations to be probed with a higher SNR when compared with convention distributed acoustic sensing methods.

In some embodiments, the method 1400 may be extended to also provide convention DAS functionality, with sensing along the entire length of the optical path.

In such embodiments, a step of receiving a local oscillator signal 1406 further comprises receiving a continuous wave, CW local oscillator signal. These embodiments also include a step of generating, based on an interference between the scattered signal and the CW local oscillator signal, a set of first complex DAS carrier signals, wherein each first complex DAS carrier signal results from interference between a frequency step of the scattered signal and the CW local oscillator signal, and is modulated by a phase difference between the CW local oscillator signal and the scattered signal at a spatial location along the optical path determined by a sampling time at which the measurement was made relative to the time of launch of the probe signal (i.e., the specific frequency step in the transmitted test signal staircase) as well as the associated frequency step of the scattered signal.

After generating the set of first complex DAS carrier signals, the method comprises a step of generating a set of second complex DAS carrier signals that are modulated by a spatial differential of the phase difference, the spatial differential being taken along a length of the optical path. For example, the set of first complex DAS carrier signals may be processed to generate the set of second complex DAS carrier signals by multiplying a complex conjugate of each first complex DAS carrier signal with a delayed copy of itself (delayed by a chosen gauge delay).

Finally, the method comprises determining, based on the set of second complex DAS carrier signals, a value representative of the spatial differential of the phase difference for the location along the optical path for distributed acoustic sensing. For example, this may be determined according to any one of the methods described above with respect to FIGS. 10-12. In this way, the method 1400 may also provide conventional distributed acoustic sensing along the length of the optical path, in conjunction with the acoustic zoom channel.

### Mathematical Treatment

By way of example, the simplified case of a 4 step test signal and a local oscillator signal comprising a frequency staircase local oscillator field and a CW local oscillator field is considered below, outlining the mathematics for this case. In the equations below, LO indicates a local oscillator signal component, the subscript DAS represents a CW signal component (e.g. a CW local oscillator field is DAS_{LO}), the subscript numbers represent the different pitch or step in a frequency staircase (e.g., 2 is the second step in a periodic step increase signal), and TX indicates a property of transmitted test signal and the subscript s indicates a scattered signal element relating to the corresponding transmitted signal element.

$$\begin{matrix} & {E}_{L O} ( t - {T}_{z} ) \cdot {e}^{i ( {ω}_{L O 1} ( t - {T}_{z} ) )} + \\ & {E}_{L O} ( t - {T}_{z} - τ ) \cdot {e}^{i ( {ω}_{L O 2} ( t - {T}_{z} - τ ) )} + \\ {E}_{LO} : & {E}_{L O} ( t - {T}_{z} - 2 τ ) \cdot {e}^{i ( {ω}_{L O 3} ( t - {T}_{z} - 2 τ ) )} + \\ & {E}_{L O} ( t - {T}_{z} - 3 τ ) \cdot {e}^{i ( {ω}_{L O 4} ( t - {T}_{z} - 3 τ ) )} + {E}_{D A S} ( t ) \cdot {e}^{i ( {ω}_{D A {S}_{L O}} ( t ) )}\end{matrix} \qquad ( 1 )$$

Defining the terms;
T_{z} is the time delay between the LO and TX staircases that determines the position of the acoustic zoom
τ is the temporal pitch of the staircase
ω_{LOn} is the frequency of the step in the TX field

Equation (1) shows the E-field resulting from a local oscillator signal comprising a frequency staircase signal (the E_{LO} components) and a CW signal (the EDAS component).

$$\begin{matrix} & {E}_{s} ( t ) \cdot {e}^{i ( {ω}_{TX 1} t + φ ( t ) + {φ}_{Bias 1} )} + \\ & {E}_{s} ( t - τ ) \cdot {e}^{i ( {ω}_{T X 2} ( t - τ ) + φ ( t - τ ) + {φ}_{B i a s 2} )} + \\ {E}_{S c a t t e r} : & {E}_{s} ( t - 2 τ ) \cdot {e}^{i ( {ω}_{T X 3 ( t - 2 τ ) + φ ( t - 2 τ ) + {φ}_{B i a s 3} )}} + \\ & {E}_{s} ( t - 3 τ ) \cdot {e}^{i ( {ω}_{T X 4} ( t - 3 τ ) + φ ( t - 3 τ ) + {φ}_{B i a s 4} )}\end{matrix} \qquad ( 2 )$$

Equation (2) shows the E-field resulting from scattering within the optical fibre, from a test signal having a periodic step increase in frequency. Considering all fields incident on a square law detection system, the intensity is given by equation (3):

$$I = 〈 ( {E}_{L O} + {E}_{Scatter} ) \cdot {( {E}_{L O} + {E}_{Scatter} )}^{*} 〉 \qquad ( 3 )$$

Expanding all of the terms in equation (3) results in

$$I = {I}_{D C} + {I}_{A {Z}_{P o s} z - 3} + {I}_{A {Z}_{P o s} z - 2} + {I}_{A {Z}_{P o s} z - 1} {+}_{A {Z}_{P o s} z 0} + {I}_{A {Z}_{P o s} z + 1} + {I}_{A {Z}_{P o s} z + 2} + {I}_{A {Z}_{P o s} z + 3} + {I}_{DAS 1} + {I}_{D A S 2} + {I}_{D A S 3} + {I}_{D A S 4} + {I}_{{Scatter}_{Xterms}} + {I}_{L {O}_{Xterms}} \qquad ( 4 )$$

Equation (4) comprises DC components and components representing the acoustic zoom signal at different positions (i.e., positions Z−3 . . . Z0 . . . Z+3, as described above).

### DC Components

The DC components are given in equation (5).

$$I = {E}_{LO} ( t - {T}_{z} ) {E}_{LO}^{*} ( t - {T}_{z} ) + {E}_{LO} ( t - {T}_{z} - τ ) {E}_{LO}^{*} ( t - {T}_{z} - τ ) + {E}_{LO} ( t - {T}_{z} - 2 τ ) {E}_{LO}^{*} ( t - {T}_{z} - 2 τ ) + {E}_{LO} ( t - {T}_{z} - 3 τ ) {E}_{LO}^{*} ( t - {T}_{z} - 3 τ ) + {E}_{s} ( t ) {E}_{s}^{*} ( t ) + {E}_{s} ( t - τ ) {E}_{s}^{*} ( t - τ ) + {E}_{s} ( t - 2 τ ) {E}_{s}^{*} ( t - 2 τ ) + {E}_{s} ( t - 3 τ ) {E}_{s}^{*} ( t - 3 τ ) + {E}_{{DAS}_{LO}} ( t ) {E}_{{DAS}_{LO}}^{*} ( t ) \qquad ( 5 )$$

These DC components are modulated by the intensity modulation as a function of time, resulting from intra-pulse interference. They are not used to advantage in the scheme but can cause crosstalk etc. if their presence is not accounted for.

### Acoustic Zoom Components

The acoustic zoom component at a position Z−3 is given in equation (6).

$${I}_{{AZ}_{Pos} z - 3} = {E}_{LO} ( t - {T}_{z} - 3 τ ) {E}_{s}^{*} ( t ) {e}^{i ( ( {ω}_{LO 4} ( t - {T}_{z} - 3 τ ) - {ω}_{TX 1} t ) - φ ( t ) - {φ}_{bias 1} )} + {E}_{s} ( t ) {E}_{LO}^{*} ( t - {T}_{z} - 3 τ ) {e}^{- i ( ( {ω}_{LO 4} ( t - {T}_{z} - 3 τ ) - {ω}_{TX 1} t ) - φ ( t ) - {φ}_{bias 1} )} \qquad ( 6 )$$

These components are at a frequency equal to the difference in frequency between a step in the LO field and the step in the test signal field three lower (z−3). Note that each part of the summation exists at a time delay relative to the next and the amplitude envelope of the local oscillator field ensures that the response moves from one term to the next as a function of time. These carry a phase modulation which is the cumulative phase modulation acting on the fibre at the position three steps prior to that defined by the time delay between the test signal and local oscillator fields.

The acoustic zoom component at a position Z−2 is given in equation (7).

$${I}_{{AZ}_{Pos} z - 2} = {E}_{LO} ( t - {T}_{z} - 2 τ ) {E}_{s}^{*} ( t ) {e}^{i ( ( {ω}_{LO 3} ( t - {T}_{z} - 2 τ ) - {ω}_{TX 1} t ) - φ ( t ) - {φ}_{bias 1} )} + {E}_{s} ( t ) {E}_{LO}^{*} ( t - {T}_{z} - 2 τ ) {e}^{- i ( ( {ω}_{LO 3} ( t - {T}_{z} - 2 τ ) - {ω}_{TX 1} t ) - φ ( t ) - {φ}_{bias 1} )} + {E}_{LO} ( t - {T}_{z} - 3 τ ) {E}_{s}^{*} ( t - τ ) {e}^{i ( ( {ω}_{LO 4} ( t - {T}_{z} - 3 τ ) - {ω}_{TX 2} ( t - τ ) ) - φ ( t - τ ) - {φ}_{bias 2} )} + {E}_{s} ( t - τ ) {E}_{LO}^{*} ( t - {T}_{z} - 3 τ ) {e}^{- i ( ( {ω}_{LO 4} ( t - {T}_{z} - 3 τ ) - {ω}_{TX 2} ( t - τ ) ) - φ ( t - τ ) - {φ}_{bias 2} )} \qquad ( 7 )$$

These components are a frequency equal to the difference in frequency between a step in the local oscillator field and the step in the test signal field two lower (z−2). Note that each part of the summation exists at a time delay relative to the next and the amplitude envelope of the LO field ensures that the response moves from one term to the next as a function of time. These carry a phase modulation which is the cumulative phase modulation acting on the fibre at the position two steps prior to that defined by the time delay between the test signal and local oscillator fields.

The acoustic zoom component at a position Z−1 is given in equation (8).

$${I}_{{AZ}_{Pos} z - 1} = {E}_{LO} ( t - {T}_{z} - τ ) {E}_{s}^{*} ( t ) {e}^{i ( ( {ω}_{LO 2} ( t - {T}_{z} - τ ) - {ω}_{TX 1} t ) - φ ( t ) - {φ}_{bias 1} )} + {E}_{s} ( t ) {E}_{LO}^{*} ( t - {T}_{z} - τ ) {e}^{- i ( ( {ω}_{LO 2} ( t - {T}_{z} - τ ) - {ω}_{TX 1} t ) - φ ( t ) - {φ}_{bias 1} )} + {E}_{LO} ( t - {T}_{z} - 2 τ ) {E}_{s}^{*} ( t - τ ) {e}^{i ( ( {ω}_{LO 3} ( t - {T}_{z} - 2 τ ) - {ω}_{TX 2} ( t - τ ) ) - φ ( t - τ ) - {φ}_{bias 2} )} + {E}_{s} ( t - τ ) {E}_{LO}^{*} ( t - {T}_{z} - 2 τ ) {e}^{- i ( ( {ω}_{LO 3} ( t - {T}_{z} - 2 τ ) - {ω}_{TX 2} ( t - τ ) ) - φ ( t - τ ) - {φ}_{bias 2} )} + {E}_{LO} ( t - {T}_{z} - 3 τ ) {E}_{s}^{*} ( t - 2 τ ) {e}^{i ( ( {ω}_{LO 4} ( t - {T}_{z} - 3 τ ) - {ω}_{TX 3} ( t - 2 τ ) ) - φ ( t - 2 τ ) - {φ}_{bias 3} )} + {E}_{s} ( t - 2 τ ) {E}_{LO}^{*} ( t - {T}_{z} - 3 τ ) {e}^{- i ( ( {ω}_{LO 4} ( t - {T}_{z} - 3 τ ) - {ω}_{TX 3} ( t - 2 τ ) ) - φ ( t - 2 τ ) - {φ}_{bias 3} )} \qquad ( 8 )$$

These components are a frequency equal to the difference in frequency between a step in the local oscillator field and the step in the test signal field one lower (z−1). Note that each part of the summation exists at a time delay relative to the next and the amplitude envelope of the local oscillator field ensures that the response moves from one term to the next as a function of time. These carry a phase modulation which is the cumulative phase modulation acting on the fibre at the position one step prior to that defined by the time delay between the test signal and local oscillator fields.

The acoustic zoom component at a location Z0 is given in equation (9).

$${I}_{{AZ}_{Pos} z 0} = {E}_{LO} ( t - {T}_{z} ) {E}_{s}^{*} ( t ) {e}^{i ( {ω}_{LO 1} ( t - {T}_{z} ) - {ω}_{TX 1} t - φ ( t ) - {φ}_{bias 1} )} + {E}_{s} ( t ) {E}_{LO}^{*} ( t - {T}_{z} ) {e}^{- i ( {ω}_{LO 1} ( t - {T}_{z} ) - {ω}_{TX 1} t - φ ( t ) - {φ}_{bias 1} )} + {E}_{LO} ( t - {T}_{z} - τ ) {E}_{s}^{*} ( t - τ ) {e}^{i ( {ω}_{LO 2} ( t - {T}_{z} - τ ) - {ω}_{TX 2} ( t - τ ) - φ ( t - τ ) - {φ}_{bias 2} )} + {E}_{s} ( t - τ ) {E}_{LO}^{*} ( t - {T}_{z} - τ ) {e}^{- i ( {ω}_{LO 2} ( t - {T}_{z} - τ ) - {ω}_{TX 2} ( t - τ ) - φ ( t - τ ) - {φ}_{bias 2} )} + {E}_{LO} ( t - {T}_{z} - 2 τ ) {E}_{s}^{*} ( t - 2 τ ) {e}^{i ( {ω}_{LO 3} ( t - {T}_{z} - 2 τ ) - {ω}_{TX 3} ( t - 2 τ ) - φ ( t - 2 τ ) - {φ}_{bias 3} )} + {E}_{s} ( t - 2 τ ) {E}_{LO}^{*} ( t - {T}_{z} - 2 τ ) {e}^{- i ( {ω}_{LO 3} ( t - {T}_{z} - 2 τ ) - {ω}_{TX 3} ( t - 2 τ ) - φ ( t - 2 τ ) - {φ}_{bias 3} )} + {E}_{LO} ( t - {T}_{z} - 3 τ ) {E}_{s}^{*} ( t - 3 τ ) {e}^{i ( {ω}_{LO 4} ( t - {T}_{z} - 3 τ ) - {ω}_{TX 4} ( t - 3 τ ) - φ ( t - 3 τ ) - {φ}_{bias 4} )} + {E}_{s} ( t - 3 τ ) {E}_{LO}^{*} ( t - {T}_{z} - 3 τ ) {e}^{- i ( {ω}_{LO 4} ( t - {T}_{z} - 3 τ ) - {ω}_{TX 4} ( t - 3 τ ) - φ ( t - 3 τ ) - {φ}_{bias 4} )} \qquad ( 9 )$$

These components are a frequency equal to the difference in frequency between a step in the local oscillator field and the corresponding step in the test signal field (Z0). Note that each part of the summation exists at a time delay relative to the next and the amplitude envelope of the local oscillator field ensures that the response moves from one term to the next as a function of time. These carry a phase modulation which is the cumulative phase modulation acting on the fibre at the position defined by the time delay between the test signal and local oscillator fields.

The acoustic zoom component at a location Z+1 is given in equation (10).

$${I}_{{AZ}_{Pos} z + 1} = {E}_{LO} ( t - {T}_{z} ) {E}_{s}^{*} ( t - τ ) {e}^{i ( ( {ω}_{LO 1} ( t - {T}_{z} ) - {ω}_{TX 2} ( t - τ ) ) - φ ( t - τ ) - {φ}_{bias 2} )} + {E}_{s} ( t - τ ) {E}_{LO}^{*} ( t - {T}_{z} ) {e}^{- i ( ( {ω}_{LO 1} ( t - {T}_{z} ) - {ω}_{TX 2} ( t - τ ) ) - φ ( t - τ ) - {φ}_{bias 2} )} + {E}_{LO} ( t - {T}_{z} - τ ) {E}_{s}^{*} ( t - 2 τ ) {e}^{i ( ( {ω}_{LO 2} ( t - {T}_{z} - τ ) - {ω}_{TX 3} ( t - 2 τ ) ) - φ ( t - 2 τ ) - {φ}_{bias 3} )} + {E}_{s} ( t - 2 τ ) {E}_{LO}^{*} ( t - {T}_{z} - τ ) {e}^{- i ( ( {ω}_{LO 2} ( t - {T}_{z} - τ ) - {ω}_{TX 3} ( t - 2 τ ) ) - φ ( t - 2 τ ) - {φ}_{bias 3} )} + {E}_{LO} ( t - {T}_{z} - 2 τ ) {E}_{s}^{*} ( t - 3 τ ) {e}^{i ( ( {ω}_{LO 3} ( t - {T}_{z} - 2 τ ) - {ω}_{TX 4} ( t - 3 τ ) ) - φ ( t - 3 τ ) - {φ}_{bias 4} )} + {E}_{s} ( t - 3 τ ) {E}_{LO}^{*} ( t - {T}_{z} - 2 τ ) {e}^{- i ( ( {ω}_{LO 3} ( t - {T}_{z} - 2 τ ) - {ω}_{TX 4} ( t - 3 τ ) ) - φ ( t - 3 τ ) - {φ}_{bias 4} )} \qquad ( 10 )$$

These components are a frequency equal to the difference in frequency between a step in the local oscillator field and the step in the test signal field one higher (Z+1). Note that each part of the summation exists at a time delay relative to the next and the amplitude envelope of the local oscillator field ensures that the response moves from one term to the next as a function of time. These carry a phase modulation which is the cumulative phase modulation acting on the fibre at the position one step after that defined by the time delay between the test signal and local oscillator fields.

The acoustic zoom component at a location Z+2 is given in equation (11).

$${I}_{{AZ}_{Pos} z + 2} = {E}_{LO} ( t - {T}_{z} ) {E}_{s}^{*} ( t - 2 τ ) {e}^{i ( ( {ω}_{LO 1} ( t - {T}_{z} ) - {ω}_{TX 3} ( t - 2 τ ) ) - φ ( t - 2 τ ) - {φ}_{bias 3} )} + {E}_{s} ( t - 2 τ ) {E}_{LO}^{*} ( t - {T}_{z} ) {e}^{- i ( ( {ω}_{LO 1} ( t - {T}_{z} ) - {ω}_{TX 3} ( t - 2 τ ) ) - φ ( t - 2 τ ) - {φ}_{bias 3} )} + {E}_{LO} ( t - {T}_{z} - τ ) {E}_{s}^{*} ( t - 3 τ ) {e}^{i ( ( {ω}_{LO 2} ( t - {T}_{z} - τ ) - {ω}_{TX 4} ( t - 3 τ ) ) - φ ( t - 3 τ ) - {φ}_{bias 4} )} + {E}_{s} ( t - 3 τ ) {E}_{LO}^{*} ( t - {T}_{z} - τ ) {e}^{- i ( ( {ω}_{LO 2} ( t - {T}_{z} - τ ) - {ω}_{TX 4} ( t - 3 τ ) ) - φ ( t - 3 τ ) - {φ}_{bias 4} )} \qquad ( 11 )$$

These components are a frequency equal to the difference in frequency between a step in the local oscillator field and the step in the test signal field two higher (Z+2). Note that each part of the summation exists at a time delay relative to the next and the amplitude envelope of the local oscillator field ensures that the response moves from one term to the next as a function of time. These carry a phase modulation which is the cumulative phase modulation acting on the fibre at the position two steps after that defined by the time delay between the test signal and local oscillator fields.

The acoustic zoom component at a location Z+3 is given in equation (12).

$${I}_{{AZ}_{Pos} z + 3} = {E}_{LO} ( t - {T}_{z} ) {E}_{s}^{*} ( t - 3 τ ) {e}^{i ( ( {ω}_{LO 1} ( t - {T}_{z} ) - {ω}_{TX 4} ( t - 3 τ ) ) - φ ( t - 3 τ ) - {φ}_{bias 4} )} + {E}_{s} ( t - 3 τ ) {E}_{LO}^{*} ( t - {T}_{z} ) {e}^{- i ( ( {ω}_{LO 1} ( t - {T}_{z} ) - {ω}_{TX 4} ( t - 3 τ ) ) - φ ( t - 3 τ ) - {φ}_{bias 4} )} \qquad ( 12 )$$

These components are a frequency equal to the difference in frequency between a step in the local oscillator field and the step in the test signal field three higher (Z+3). Note that each part of the summation exists at a time delay relative to the next and the amplitude envelope of the local oscillator field ensures that the response moves from one term to the next as a function of time. These carry a phase modulation which is the cumulative phase modulation acting on the fibre at the position three steps after that defined by the time delay between the test signal and local oscillator fields.

### Conventional DAS Components

As well as the acoustic zoom carriers described above, as the local oscillator signal also comprises a CW local oscillator field, the fields incident on a square law detection system also comprise a number of components which can be used for conventional DAS analysis (which may be referred to below as ‘normal’ DAS) as described above. The intensity components for this normal DAS signal are described by equations (13)-(16) below.

$${I}_{DAS 1} = {E}_{s} ( t ) {E}_{DAS\_LO}^{*} ( t ) {e}^{i ( ( {ω}_{{DAS}_{LO}} - {ω}_{TX 1} ) t - φ ( t ) - {φ}_{bias 1} )} + {E}_{DAS\_LO} ( t ) {E}_{s}^{*} ( t ) {e}^{- i ( ( {ω}_{{DAS}_{LO}} - {ω}_{TX 1} ) t - φ ( t ) - {φ}_{bias 1} )} \qquad ( 13 )$$

This component is a normal DAS carrier at a frequency equal to the difference in frequency between the CW local oscillator field and the first step in the test signal field. This carrier is modulated by the cumulative phase modulation acting on the fibre and the position is defined by the sample time.

$${I}_{DAS 2} = {E}_{s} ( t - τ ) {E}_{DAS\_LO}^{*} ( t ) {e}^{i ( {ω}_{DAS\_LO} t - {ω}_{TX 2} ( t - τ ) - φ ( t - τ ) - {φ}_{bias 2} )} + {E}_{DAS\_LO} ( t ) {E}_{s}^{*} ( t - τ ) {e}^{- i ( {ω}_{DAS\_LO} t - {ω}_{TX 2} ( t - τ ) - φ ( t - τ ) - {φ}_{bias 2} )} \qquad ( 14 )$$

This component is a normal DAS carrier at a frequency equal to the difference in frequency between the CW local oscillator field and the second step in the test signal field. This carrier is modulated by the cumulative phase modulation acting on the fibre and the position is defined by the sample time minus a step period.

$${I}_{DAS 3} = {E}_{s} ( t - 2 τ ) {E}_{DAS\_LO}^{*} ( t ) {e}^{i ( {ω}_{{DAS}_{LO}} t - {ω}_{TX 3} ( t - 2 τ ) - φ ( t - 2 τ ) - {φ}_{bias 3} )} + {E}_{DAS\_LO} ( t ) {E}_{s}^{*} ( t - 2 τ ) {e}^{- i ( {ω}_{{DAS}_{LO}} t - {ω}_{TX 3} ( t - 2 τ ) - φ ( t - 2 τ ) - {φ}_{bias 3} )} \qquad ( 15 )$$

This component is a normal DAS carrier at a frequency equal to the difference in frequency between the CW local oscillator field and the third step in the test signal field. This carrier is modulated by the cumulative phase modulation acting on the fibre and the position is defined by the sample time minus two step periods.

$${I}_{DAS 4} = {E}_{s} ( t - 3 τ ) {E}_{DAS\_LO}^{*} ( t ) {e}^{i ( {ω}_{DAS\_LO} t - {ω}_{TX 4} ( t - 3 τ ) - φ ( t - 3 τ ) - {φ}_{bias 4} )} + {E}_{DAS\_LO} ( t ) {E}_{s}^{*} ( t - 3 τ ) {e}^{- i ( {ω}_{DAS\_LO} t - {ω}_{TX 4} ( t - 3 τ ) - φ ( t - 3 τ ) - {φ}_{bias 4} )} \qquad ( 16 )$$

This component is a normal DAS carrier at a frequency equal to the difference in frequency between the CW local oscillator field and the fourth step in the test signal field. This carrier is modulated by the cumulative phase modulation acting on the fibre and the position is defined by the sample time minus three step periods.

$$\begin{matrix}Scatter Interference Components & \\ {I}_{{Scatter}_{Xterms}} = {E}_{s} ( t ) {E}_{s}^{*} ( t - τ ) {e}^{i ( {ω}_{TX 1} t - {ω}_{TX 2} ( t - τ ) + φ ( t ) - φ ( t - τ ) + {φ}_{bias 1} - {φ}_{bias 2} )} + {E}_{s} ( t - τ ) {E}_{s}^{*} ( t ) {e}^{- i ( {ω}_{TX 1} t - {ω}_{TX 2} ( t - τ ) + φ ( t ) - φ ( t - τ ) + {φ}_{bias 1} - {φ}_{bias 2} )} + {E}_{s} ( t - τ ) {E}_{s}^{*} ( t - 2 τ ) {e}^{i ( {ω}_{TX 2} ( t - τ ) - {ω}_{TX 3} ( t - 2 τ ) + φ ( t - τ ) - φ ( t - 2 τ ) + {φ}_{bias 2} - {φ}_{bias 3} )} + {E}_{s} ( t - 2 τ ) {E}_{s}^{*} ( t - τ ) {e}^{- i ( {ω}_{TX 2} ( t - τ ) - {ω}_{TX 3} ( t - 2 τ ) + φ ( t - τ ) - φ ( t - 2 τ ) + {φ}_{bias 2} - {φ}_{bias 3} )} + {E}_{s} ( t - 2 τ ) {E}_{s}^{*} ( t - 3 τ ) {e}^{i ( {ω}_{TX 3} ( t - 2 τ ) - {ω}_{TX 4} ( t - 3 τ ) + φ ( t - 2 τ ) - φ ( t - 3 τ ) + {φ}_{bias 3} - {φ}_{bias 4} )} + {E}_{s} ( t - 3 τ ) {E}_{s}^{*} ( t - 2 τ ) {e}^{- i ( {ω}_{TX 3} ( t - 2 τ ) - {ω}_{TX 4} ( t - 3 τ ) + φ ( t - 2 τ ) - φ ( t - 3 τ ) + {φ}_{bias 3} - {φ}_{bias 4} )} + {E}_{s} ( t ) {E}_{s}^{*} ( t - 2 τ ) {e}^{i ( {ω}_{TX 1} t - {ω}_{TX 3} ( t - 2 τ ) + φ ( t ) - φ ( t - 2 τ ) + {φ}_{bias 1} - {φ}_{bias 3} )} + {E}_{s} ( t - 2 τ ) {E}_{s}^{*} ( t ) {e}^{- i ( {ω}_{TX 1} t - {ω}_{TX 3} ( t - 2 τ ) + φ ( t ) - φ ( t - 2 τ ) + {φ}_{bias 1} - {φ}_{bias 3} )} + {E}_{s} ( t - τ ) {E}_{s}^{*} ( t - 3 τ ) {e}^{i ( {ω}_{TX 2} ( t - τ ) - {ω}_{TX 4} ( t - 3 τ ) + φ ( t - τ ) - φ ( t - 3 τ ) + {φ}_{bias 2} - {φ}_{bias 4} )} + {E}_{s} ( t - 3 τ ) {E}_{s}^{*} ( t - τ ) {e}^{- i ( {ω}_{TX 2} ( t - τ ) - {ω}_{TX 4} ( t - 3 τ ) + φ ( t - τ ) - φ ( t - 3 τ ) + {φ}_{bias 2} - {φ}_{bias 4} )} + {E}_{s} ( t ) {E}_{s}^{*} ( t - 3 τ ) {e}^{i ( {ω}_{TX 1} t - {ω}_{TX 4} ( t - 3 τ ) + φ ( t ) - φ ( t - 3 τ ) + {φ}_{bias 1} - {φ}_{bias 4} )} + {E}_{s} ( t - 3 τ ) {E}_{s}^{*} ( t ) {e}^{- i ( {ω}_{TX 1} t - {ω}_{TX 4} ( t - 3 τ ) + φ ( t ) - φ ( t - 3 τ ) + {φ}_{bias 1} - {φ}_{bias 4} )} & ( 17 )\end{matrix}$$

The components shown in equation (17) are created by the interference between the scatter terms from each step in the test signal field themselves. The amplitudes of these components is very small when compared to the terms containing a local oscillator interference term however care is required to not allow them to interfere with a wanted term.

$$\begin{matrix}Local Oscillator Interference Terms & \\ {I}_{{LO}_{Xterms}} = {E}_{LO} ( t - {T}_{z} ) {E}_{DAS\_LO}^{*} ( t ) {e}^{i ( {ω}_{DAS\_LO} t - {ω}_{LO 1} ( t - {T}_{z} ) )} + {E}_{DAS\_LO} ( t ) {E}_{LO}^{*} ( t - {T}_{z} ) {e}^{- i ( {ω}_{DAS\_LO} t - {ω}_{LO 1} ( t - {T}_{z} ) )} + {E}_{LO} ( t - {T}_{z} - τ ) {E}_{DAS\_LO}^{*} ( t ) {e}^{i ( {ω}_{DAS\_LO} t - {ω}_{LO 2} ( t - {T}_{z} - τ ) )} + {E}_{DAS\_LO} ( t ) {E}_{LO}^{*} ( t - {T}_{z} - τ ) {e}^{- i ( {ω}_{DAS\_LO} t - {ω}_{LO 2} ( t - {T}_{z} - τ ) )} + {E}_{LO} ( t - {T}_{z} - 2 τ ) {E}_{DAS\_LO}^{*} ( t ) {e}^{i ( {ω}_{DAS\_LO} t - {ω}_{LO 3} ( t - {T}_{z} - 2 τ ) )} + {E}_{DAS\_LO} ( t ) {E}_{LO}^{*} ( t - {T}_{z} - 2 τ ) {e}^{- i ( {ω}_{DAS\_LO} t - {ω}_{LO 3} ( t - {T}_{z} - 2 τ ) )} + {E}_{LO} ( t - {T}_{z} - 3 τ ) {E}_{DAS\_LO}^{*} ( t ) {e}^{i ( {ω}_{DAS\_LO} t - {ω}_{LO 4} ( t - {T}_{z} - 3 τ ) )} + {E}_{DAS\_LO} ( t ) {E}_{LO}^{*} ( t - {T}_{z} - 3 τ ) {e}^{- i ( {ω}_{DAS\_LO} t - {ω}_{LO 4} ( t - {T}_{z} - 3 τ ) )} & ( 18 )\end{matrix}$$

The components shown in equation (18) are created by the interference between the CW local oscillator signal and the frequency stepped acoustic zoom local oscillator signal directly. These terms will be very large amplitude but are modulated only by the phase difference between the CW local oscillator field and the frequency stepped acoustic zoom local oscillator field which should be constant. These components are therefore narrow bandwidth tonals at a stable constant phase.

The mathematics can be further simplified if the assumption is made that the E-field amplitudes are purely real then these terms again simplify as shown in equations (19)-(33)

$$\begin{matrix}DC Components & \\ I = {\vert {E}_{LO} ( t - {T}_{z} ) \vert}^{2} + {\vert {E}_{LO} ( t - {T}_{z} - τ ) \vert}^{2} + {\vert {E}_{LO} ( t - {T}_{z} - 2 τ ) \vert}^{2} + {\vert {E}_{LO} ( t - {T}_{z} - 3 τ ) \vert}^{2} + {\vert {E}_{s} ( t ) \vert}^{2} + {\vert {E}_{s} ( t - τ ) \vert}^{2} + {\vert {E}_{s} ( t - 2 τ ) \vert}^{2} + {\vert {E}_{s} ( t - 3 τ ) \vert}^{2} + {\vert {E}_{{DAS}_{LO}} ( t ) \vert}^{2} & ( 19 )\end{matrix}$$

$$\begin{matrix}Acoustic Zoom Position z - 3 & \\ {I}_{{Az}_{Pos} z - 3} = 2 {E}_{LO} ( t - {T}_{z} - 3 τ ) {E}_{s} ( t ) cos ( {ω}_{LO 4} ( t - {T}_{z} - 3 τ ) - {ω}_{TX 1} t - φ ( t ) - {φ}_{bias 1} ) & ( 20 )\end{matrix}$$

$$\begin{matrix}Acoustic Zoom Position z - 2 & \\ {I}_{{Az}_{Pos} z - 2} = 2 {E}_{LO} ( t - {T}_{z} - 2 τ ) {E}_{s} ( t ) cos ( {ω}_{LO 3} ( t - {T}_{z} - 2 τ ) - {ω}_{TX 1} t - φ ( t ) - {φ}_{bias 1} ) + 2 {E}_{LO} ( t - {T}_{z} - 3 τ ) {E}_{s} ( t - τ ) cos ( {ω}_{LO 4} ( t - {T}_{z} - 3 τ ) - {ω}_{TX 2} ( t - τ ) - φ ( t - τ ) - {φ}_{bias 2} ) & ( 21 )\end{matrix}$$

$$\begin{matrix}Acoustic Zoom Position z - 2 & \\ {I}_{{Az}_{Pos} z - 1} = 2 {E}_{LO} ( t - {T}_{z} - τ ) {E}_{s} ( t ) cos ( {ω}_{LO 2} ( t - {T}_{z} - τ ) - {ω}_{TX 1} t - φ ( t ) - {φ}_{bias 1} ) + 2 {E}_{LO} ( t - {T}_{z} - 2 τ ) {E}_{s} ( t - τ ) cos ( {ω}_{LO 3} ( t - {T}_{z} - 2 τ ) - {ω}_{TX 2} ( t - τ ) - φ ( t - τ ) - {φ}_{bias 2} ) + 2 {E}_{LO} ( t - {T}_{z} - 3 τ ) {E}_{s} ( t - 2 τ ) cos ( {ω}_{LO 4} ( t - {T}_{z} - 3 τ ) - {ω}_{TX 3} ( t - τ2 ) - φ ( t - 2 τ ) - {φ}_{bias 3} ) & ( 22 )\end{matrix}$$

$$\begin{matrix}Acoustic Zoom Position z0 & \\ {I}_{{Az}_{Pos} z 0} = 2 {E}_{LO} ( t - {T}_{z} ) {E}_{s} ( t ) cos ( {ω}_{LO 1} ( t - {T}_{z} ) - {ω}_{TX 1} t - φ ( t ) - {φ}_{bias 1} ) + 2 {E}_{LO} ( t - {T}_{z} - τ ) {E}_{s} ( t - τ ) cos ( {ω}_{LO 2} ( t - {T}_{z} - τ ) - {ω}_{TX 2} ( t - τ ) - φ ( t - τ ) - {φ}_{bias 2} ) + 2 {E}_{LO} ( t - {T}_{z} - 2 τ ) {E}_{s} ( t - 2 τ ) cos ( {ω}_{LO 3} ( t - {T}_{z} - 2 τ ) - {ω}_{TX 3} ( t - 2 τ ) - φ ( t - 2 τ ) - {φ}_{bias 3} ) + 2 {E}_{LO} ( t - {T}_{z} - 3 τ ) {E}_{s} ( t - 3 τ ) cos ( {ω}_{LO 4} ( t - {T}_{z} - 3 τ ) - {ω}_{TX 4} ( t - 3 τ ) - φ ( t - 3 τ ) - {φ}_{bias 4} ) & ( 23 )\end{matrix}$$

$$\begin{matrix}Acoustic Zoom Position z + 1 & \\ {I}_{{Az}_{Pos} z + 1} = 2 {E}_{LO} ( t - {T}_{z} ) {E}_{s} ( t - τ ) cos ( {ω}_{LO 1} ( t - {T}_{z} ) - {ω}_{TX 2} ( t - τ ) - φ ( t - τ ) - {φ}_{bias 2} ) + 2 {E}_{LO} ( t - {T}_{z} - τ ) {E}_{s} ( t - 2 τ ) cos ( {ω}_{LO 2} ( t - {T}_{z} - τ ) - {ω}_{TX 3} ( t - 2 τ ) - φ ( t - 2 τ ) - {φ}_{bias 3} ) + 2 {E}_{LO} ( t - {T}_{z} - 2 τ ) {E}_{s} ( t - 2 τ ) cos ( {ω}_{LO 3} ( t - {T}_{z} - 2 τ ) - {ω}_{TX 4} ( t - 3 τ ) - φ ( t - 3 τ ) - {φ}_{bias 4} ) & ( 24 )\end{matrix}$$

$$\begin{matrix}Acoustic Zoom Position z + 2 & \\ {I}_{{Az}_{Pos} z + 2} = 2 {E}_{LO} ( t - {T}_{z} ) {E}_{s} ( t - 2 τ ) cos ( {ω}_{LO 1} ( t - {T}_{z} ) - {ω}_{TX 3} ( t - 2 τ ) - φ ( t - 2 τ ) - {φ}_{bias 3} ) + 2 {E}_{LO} ( t - {T}_{z} - τ ) {E}_{s} ( t - 3 τ ) cos ( {ω}_{LO 2} ( t - {T}_{z} - τ ) - {ω}_{TX 4} ( t - 3 τ ) - φ ( t - 3 τ ) - {φ}_{bias 4} ) & ( 25 )\end{matrix}$$

$$\begin{matrix}Acoustic Zoom Position z + 3 & \\ {I}_{{Az}_{Pos} z + 3} = 2 {E}_{LO} ( t - {T}_{z} ) {E}_{s} ( t - 3 τ ) cos ( {ω}_{LO 1} ( t - {T}_{z} ) - {ω}_{TX 4} ( t - 3 τ ) - φ ( t - 3 τ ) - {φ}_{bias 4} ) & ( 26 )\end{matrix}$$

$$\begin{matrix}Normal DAS Carrier 1 & \\ {I}_{DAS 1} = 2 {E}_{s} ( t ) {E}_{DAS\_LO} ( t ) cos ( ( {ω}_{{DAS}_{LO}} - {ω}_{TX 1} ) t - φ ( t ) - {φ}_{bias 1} ) & ( 27 )\end{matrix}$$

$$\begin{matrix}Normal DAS Carrier 2 & \\ {I}_{DAS 2} = 2 {E}_{s} ( t - τ ) {E}_{DAS\_LO} ( t ) cos ( {ω}_{DAS\_LO} t - {ω}_{TX 2} ( t - τ ) - φ ( t - τ ) - {φ}_{bias 2} ) & ( 28 )\end{matrix}$$

$$\begin{matrix}Normal DAS Carrier 3 & \\ {I}_{DAS 3} = 2 {E}_{s} ( t - 2 τ ) {E}_{DAS\_LO} ( t ) cos ( {ω}_{DAS\_LO} t - {ω}_{TX 3} ( t - 2 τ ) - φ ( t - 2 τ ) - {φ}_{bias 3} ) & ( 29 )\end{matrix}$$

$$\begin{matrix}Normal DAS Carrier 4 & \\ {I}_{DAS 4} = 2 {E}_{s} ( t - 3 τ ) {E}_{DAS\_LO} ( t ) cos ( {ω}_{DAS\_LO} t - {ω}_{TX 4} ( t - 3 τ ) - φ ( t - 3 τ ) - {φ}_{bias 4} ) & ( 30 )\end{matrix}$$

$$\begin{matrix}Scatter Interference Terms & \\ {I}_{{Scatter}_{Xterms}} = {E}_{s} ( t ) {E}_{s} ( t - τ ) cos ( {ω}_{TX 1} t - {ω}_{TX 2} ( t - τ ) + φ ( t - τ ) + {φ}_{bias 1} - {φ}_{bias 2} ) + 2 {E}_{s} ( t - τ ) {E}_{s} ( t - 2 τ ) cos ( {ω}_{TX 2} ( t - τ ) - {ω}_{TX 3} ( t - 2 τ ) + φ ( t - τ ) - φ ( t - 2 τ ) + {φ}_{bias 2} - {φ}_{bias 3} ) + {E}_{s} ( t - 2 τ ) {E}_{s} ( t - 3 τ ) cos ( {ω}_{TX 3} ( t - 2 τ ) - {ω}_{TX 4} ( t - 3 τ ) + φ ( t - 2 τ ) - φ ( t - 3 τ ) + {φ}_{bias 3} - {φ}_{bias 4} ) + {E}_{s} ( t ) {E}_{s} ( t - τ ) cos ( {ω}_{TX 1} t - {ω}_{TX 2} ( t - τ ) + φ ( t - τ ) + {φ}_{bias 1} - {φ}_{bias 2} ) + 2 {E}_{s} ( t ) {E}_{s} ( t - 2 τ ) cos ( {ω}_{TX 1} t - {ω}_{TX 3} ( t - 2 τ ) + φ ( t ) - φ ( t - 2 τ ) + {φ}_{bias 1} - {φ}_{bias 3} ) + {E}_{s} ( t ) {E}_{s} ( t - τ ) cos ( {ω}_{TX 1} t - {ω}_{TX 2} ( t - τ ) + φ ( t - τ ) + {φ}_{bias 1} - {φ}_{bias 2} ) + 2 {E}_{s} ( t - τ ) {E}_{s} ( t - 3 τ ) cos ( {ω}_{TX 2} ( t - τ ) - {ω}_{TX 4} ( t - 3 τ ) + φ ( t - τ ) - φ ( t - 3 τ ) + {φ}_{bias 2} - {φ}_{bias 4} ) + {E}_{s} ( t ) {E}_{s} ( t - 3 τ ) cos ( {ω}_{TX 1} t - {ω}_{TX 4} ( t - 3 τ ) + φ ( t ) - φ ( t - 3 τ ) + {φ}_{bias 1} - {φ}_{bias 4} ) & ( 31 )\end{matrix}$$

$$\begin{matrix}L O Interference Terms & \\ {I}_{{LO}_{Xterms}} = 2 {E}_{LO} ( t - {T}_{z} ) {E}_{DAS\_LO} ( t ) cos ( {ω}_{DAS\_LO} t - {ω}_{LO 1} ( t - {T}_{z} ) ) + 2 {E}_{LO} ( t - {T}_{z} - τ ) {E}_{DAS\_LO} ( t ) cos ( {ω}_{DAS\_LO} t - {ω}_{LO 2} ( t - {T}_{z} - τ ) ) + 2 {E}_{LO} ( t - {T}_{z} - 2 τ ) {E}_{DAS\_LO} ( t ) cos ( {ω}_{DAS\_LO} t - {ω}_{LO 3} ( t - {T}_{z} - 2 τ ) ) + 2 {E}_{LO} ( t - {T}_{z} - 3 τ ) {E}_{DAS\_LO} ( t ) cos ( {ω}_{DAS\_LO} t - {ω}_{LO 4} ( t - {T}_{z} - 3 τ ) ) & ( 32 )\end{matrix}$$

The features disclosed in the foregoing description, or in the following claims, or in the accompanying drawings, expressed in their specific forms or in terms of a means for performing the disclosed function, or a method or process for obtaining the disclosed results, as appropriate, may, separately, or in any combination of such features, be utilised for realising the invention in diverse forms thereof.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention.

For the avoidance of any doubt, any theoretical explanations provided herein are provided for the purposes of improving the understanding of a reader. The inventors do not wish to be bound by any of these theoretical explanations.

Any section headings used herein are for organizational purposes only and are not to be construed as limiting the subject matter described.

Throughout this specification, including the claims which follow, unless the context requires otherwise, the word “comprise” and “include”, and variations such as “comprises”, “comprising”, and “including” will be understood to imply the inclusion of a stated integer or step or group of integers or steps but not the exclusion of any other integer or step or group of integers or steps.

It must be noted that, as used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by the use of the antecedent “about,” it will be understood that the particular value forms another embodiment. The term “about” in relation to a numerical value is optional and means for example+/−10%.

1. A distributed acoustic sensing system comprising:
a coherent light source configured to generate a light signal;
a launch stage configured to receive the light signal from the light source, generate a test signal, and launch the test signal along an optical path, wherein the test signal comprises a periodic step increase in frequency;
a local oscillator stage configured to generate a local oscillator signal, wherein the local oscillator signal comprises a periodic step increase in frequency which is offset relative to the test signal in each of a time domain and a frequency domain; and
a detector stage configured to:
receive the local oscillator signal from the local oscillator stage and a scattered signal from the optical path; and
interfere the local oscillator signal with the scattered signal to produce an output signal having interference terms between the scattered signal and the local oscillator signal.

2. A distributed acoustic sensing system according to claim 1, wherein the periodic step increase in frequency of the test signal is configured to separate the interference terms in the output signal to minimise spectral overlap or crosstalk.

3. A distributed acoustic sensing system according to claim 1, wherein the periodic step increase in frequency of the test signal is configured to achieve a predetermined spatial resolution.

4. A distributed acoustic sensing system according to claim 1, wherein the launch stage is configured to pulse the test signal such that successive pulses of the test signal comprise different frequencies.

5. A distributed acoustic sensing system according to claim 1, wherein the local oscillator stage is configured to also generate a continuous wave (“CW”); CW, local oscillator signal.

6. A distributed acoustic sensing system according to claim 5, wherein the local oscillator stage is configured to offset the CW local oscillator signal relative to the local oscillator signal in a frequency domain to separate interference terms in the output signal.

7. A distributed acoustic sensing system according to claim 5, wherein the launch stage is configured to generate a test signal further comprising an interrogation pulse having a fixed frequency, which is offset relative to the CW local oscillator signal in the frequency domain.

8. A signal processing method for a distributed acoustic sensing, DAS, system comprising an acoustic zoom channel, the method comprising:
transmitting a pulsed test signal along an optical path, wherein the test signal comprises a periodic step increase in frequency;
receiving, at a detector stage, a scattered signal that was scattered at a location along the optical path, wherein the scattered signal comprises a periodic step increase in frequency corresponding with the pulsed test signal;
receiving, at the detector stage, a local oscillator signal which is offset relative to the test signal in each of a time domain and a frequency domain, wherein the local oscillator signal comprises a periodic step increase in frequency;
generating, based on an interference between the scattered signal and the local oscillator signal, a set of first complex acoustic zoom carrier signals, wherein each first complex acoustic zoom carrier signal results from interference between a frequency step of the scattered signal and a frequency step of the local oscillator signal and is modulated by a phase difference between the local oscillator signal and the scattered signal at a spatial location along the optical path determined by the time offset between the pulsed test signal and the local oscillator signal as well as the associated frequency step of the scattered signal;
generating a set of second complex acoustic zoom carrier signals that are modulated by a spatial differential of the phase difference, the spatial differential being taken along a length of the optical path, based on interference between first complex acoustic zoom carrier signals; and
determining, based on the set of second complex acoustic zoom carrier signals, a value representative of the spatial differential of the phase difference for the location along the optical path for acoustic zoom sensing.

9. A signal processing method according to claim 8, wherein the DAS system further comprises a distributed acoustic sensing, DAS, channel, and wherein the method further comprises:
receiving, at a detector stage, a continuous wave, CW, local oscillator signal;
generating, based on an interference between the scattered signal and the CW local oscillator signal, a set of first complex DAS carrier signals, wherein each first complex DAS carrier signal results from interference between a frequency step of the scattered signal and the CW local oscillator signal, and is modulated by a phase difference between the CW local oscillator signal and the scattered signal at a spatial location along the optical path determined by a sampling time as well as the associated frequency step of the scattered signal;
generating a set of second complex DAS carrier signals that are modulated by a spatial differential of the phase difference, the spatial differential being taken along a length of the optical path; and
determining, based on the set of second complex DAS carrier signals, a value representative of the spatial differential of the phase difference for the location along the optical path for distributed acoustic sensing.

10. A signal processing method according to claim 9, wherein generating a set of second complex DAS carrier signals comprises aligning each of the first complex DAS carrier signals in time.

11. A signal processing method according to claim 9, wherein determining the value representative of the spatial differential of the phase difference for distributed acoustic zoom sensing comprises:
processing the set of second complex DAS carrier signals to generate a set of third complex DAS carrier signals, the set of third complex DAS carrier signals being modulated by a time differential of the spatial differential of the phase difference, the time differential being over a time period between successive pulses of the test signal; and
summing the set of third complex DAS carrier signals.

12. A signal processing method according to claim 9, wherein determining the value representative of the spatial differential of the phase difference for distributed acoustic sensing comprises:
representing the second set of complex DAS carrier signals as a set of phasors;
determining a time averaged individual reference phase for each of the set of phasors;
rotating each phasor in the set of phasors by an angle corresponding to a difference between a common reference phasor and the individual reference phasor, wherein the common reference phasor is determined based on a sum of the individual reference phasors representing the set of second complex DAS carrier signals; and
summing the rotated phasors to generate a phasor representing a third complex DAS carrier signal.

13. A signal processing method according to claim 9, wherein determining the value representative of the spatial differential of the phase difference for distributed acoustic sensing comprises:
storing an initial set of second complex DAS carrier signals generated for each spatial location as a set of reference complex DAS carrier signals for each spatial location; and
generating a set of third complex DAS carrier signals associated with each spatial location, each third complex DAS carrier signal being modulated by a phase difference between the associated second complex DAS carrier signal and the associated reference complex DAS carrier signal;
summing the set of third complex DAS carrier signals associated with each spatial location, to generate a fourth complex DAS carrier signal;
determining, based on the fourth complex DAS carrier signal, a value representative of an instantaneous frequency of an acoustic modulation at locations on the optical path corresponding to the respective spatial locations;
determining if the value representative of the instantaneous frequency meets a predetermined condition and, if the predetermined condition is met:
for each of the respective spatial locations, saving the second complex DAS carrier signal associated with that spatial location as the reference complex DAS carrier signal for that spatial location.

14. A signal processing method according to claim 8, wherein determining the value representative of the spatial differential of the phase difference for acoustic zoom sensing comprises:
processing the set of second complex acoustic zoom carrier signals to generate a set of third complex acoustic zoom carrier signals, the set of third complex acoustic zoom carrier signals being modulated by a time differential of the spatial differential of the phase difference, the time differential being over a time period between successive pulses of the test signal; and
summing the set of third complex acoustic zoom carrier signals.

15. A signal processing method according to claim 1, wherein determining the value representative of the spatial differential of the phase difference for acoustic zoom sensing comprises:
representing the second set of complex acoustic zoom carrier signals as a set of phasors;
determining a time averaged individual reference phasor for each of the set of phasors;
rotating each phasor in the set of phasors by an angle corresponding to a difference between a common reference phasor and the individual reference phasor, wherein the common reference phasor is determined based on a sum of the individual reference phasors representing the set of second complex acoustic zoom carrier signals; and
summing the rotated phasors to generate a phasor representing a third complex acoustic zoom carrier signal.

16. A signal processing method according to claim 9, wherein determining the value representative of the spatial differential of the phase difference for acoustic zoom sensing comprises:
storing an initial set of second complex acoustic zoom carrier signals generated for each spatial location as a set of reference complex acoustic zoom carrier signals for each spatial location; and
generating a set of third complex acoustic zoom carrier signals associated with each spatial location, each third complex acoustic zoom carrier signal being modulated by a phase difference between the associated second complex acoustic zoom carrier signal and the associated reference complex acoustic zoom carrier signal;
summing the set of third complex acoustic zoom carrier signals associated with each spatial location, to generate a fourth complex acoustic zoom carrier signal;
determining, based on the fourth complex acoustic zoom carrier signal, a value representative of an instantaneous frequency of an acoustic modulation at locations on the optical path corresponding to the respective spatial locations;
determining if the value representative of the instantaneous frequency meets a predetermined condition and, if the predetermined condition is met:
for each of the respective spatial locations, saving the second complex acoustic zoom carrier signal associated with that spatial location as the reference complex acoustic zoom carrier signal for that spatial location.
